(19) United States
(12) Patent Application Publication
(10) Pub. No.: US 2010/0153862 A1
(43) Pub. Date: Jun. 17, 2010

(54) General Object Graph for Web Users

(75) Inventor: Zvi Schreiber, Jerusalem (IL)

Correspondence Address: SIMON KAHN - PYI Tech, Ltd.;c/o LANDONIP, INC, 1725 Jamieson Avenue, ALEXANDRIA, VA, 22314, US

(73) Assignee: GHOST, INC., Tortola (VG)

(21) Appl. No.: 12/530,464

(22) PCT Filed: Mar. 9, 2008
(86) PCT No.: PCT/IL08/00320

§ 371 Date: Feb. 6, 2010

Related U.S. Application Data
(60) Provisional application No. 60/893,968, filed on Mar. 9, 2007.

(51) Int. Cl. G06F 9/44; G06F 15/16; G06F 17/30; H04L 9/32; G06F 21/00; G06F 3/01; G06F 3/048

(52) U.S. Cl. 715/760; 717/116; 709/203; 707/802; 726/8; 707/E17.044; 715/769

(57) ABSTRACT

A General Object Graph is described arranged for sharing structured data between users and between applications and for social networking between the users, an associated graphical user interface and application to a virtual file system with an associated authorization scheme. A distributed version of the General Object Graph is also presented known as a General Object Graph.

### CROSS-REFERENCE TO RELATED APPLICATIONS

This application claims priority from U.S. Provisional Patent Application Ser. No. 60,893,968 filed Mar. 9, 2007, entitled “VIRTUAL HOSTED OPERATING SYSTEM” the entire contents of which is incorporated herein by reference.

This application is further related to the following co-pending, co-filed and co-assigned patent applications, the entire contents of each of which are incorporated herein in their entirety by reference: “A VIRTUAL IDENTITY SYSTEM AND METHOD FOR WEB SERVICES”, docket GHO-005-PCT; “VIRTUAL FILE SYSTEM FOR THE WEB” docket GHO-006-PCT; “SYSTEM AND METHOD FOR BROWSER WITHIN A WEB SITE AND PROXY SERVER” docket GHO-008-PCT; and “SYSTEM AND METHOD FOR A VIRTUAL HOSTED OPERATING SYSTEM” docket GHO-009-PCT.

### BACKGROUND OF THE INVENTION

The invention is related to computer software and specifically to managing graphs of data objects which may be distributed and have changing schemas and which may be applied to application interoperability and to social networking on the Web.

In object oriented programming languages, objects exist each of which has attributes comprising name-value pairs where the value can optionally be a pointer at another object. Typically a “schema” exists comprising classes and associations which provide templates for objects; the classes are typically related by inheritance. The objects and the pointers/attributes/variables that connect between them are known as an object graph.

Distributed object graphs are incorporated in products available from, inter alia, Terracota Inc. of San Francisco, Calif., such as Terracotta DSO, which federates graphs in the Java programming language. Usually, distributed object graphs utilize consistent technologies such as Java or a neutral object format such as CORBA and these do not normally support a flexible schema.

The Semantic Web activity of the World Wide Web Consortium of Cambridge Mass. also provides standards known as RDF and OWL for creating distributed information models.

Extensible databases, where users can add new categories at runtime, such as Google Base from Google Inc., are available commercially, however these extensible databases are flat in that there are no structured links between objects based on their classes or types but only based on text and URLs. There is also no inheritance hierarchy of classes. Another more sophisticated extensible database, which went live after the priority date of this application, is Freebase by Metaweb Technologies of San Francisco, Calif., (www.freebase.com); however it is limited to one object graph with extensible schema and does not provide a distributed object graph.

Social Networking via the World Wide Web is well known from such services as FaceBook.com from Facebook Inc. of Palo Alto, Calif., myspace.com and LinkedIn from LinkedIn Corporation of Palo Alto, Calif. Currently such services allow a user to find other people via fixed attributes such as: name; address; via mutual acquaintances; via specific content like music playlists; and/or via keyword search, but not in other more structured and flexible ways.

What is needed, and not supplied by the prior art, is a general object graph arranged for sharing structured data between and users and between applications providing increased flexibility.

### SUMMARY OF THE INVENTION

Certain embodiments of the present invention describes a General Object Graph for sharing structured data between users and between applications and for social networking between the users, an associated graphical user interface and application to a virtual file system with an associated authorization scheme. A distributed version of the General Object Graph is also presented known as a Federated General Object Graph.

In certain embodiments, the invention provides for a computer implemented system exhibiting persistence for a graph of objects where the schema of the objects is changeable at runtime, the system comprising: a server supporting a General Object Graph, the General Object Graph comprising: a plurality of Objects; and a plurality of Classes, a client application, wherein instances of the client application are operative on a plurality of computing platforms each in communication with the server to view and edit the General Object Graph.

In certain embodiments the invention independently provides for a social networking system comprising: a persistence server; an object graph including concepts of classes, associations, objects and attributes, stored on the persistence server, where some of the objects correspond to real world items; and a client software operative to enable a plurality of users to view the object graph, wherein at least one of the classes represents a class of people; and at least one of the associations has a source or type of a class which represents a class of people.

In certain embodiments the invention independently provides a system for data interoperability between applications comprising: a persistence server; an object graph including concepts of classes, associations, objects and attributes, stored on the persistence server, where some of the objects correspond to real world items; a graphical user interface including icons which correspond to the objects; and a graphical user interface for moving the icons between different applications.

In certain embodiments the invention independently provides a computer implemented method for persisting a graph of objects where the schema of the objects is changeable at runtime, the method comprising: providing a General Object Graph; and providing a client application, wherein the General Object Graph comprises: a plurality of Objects; and a plurality of Classes, wherein instances of the client application each provide for: viewing and editing the General Object Graph.

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 illustrates a high level system architecture for a General Object Graph in accordance with certain embodiments of the invention;

FIG. 2 illustrates a UML Class Diagram Metamodel for a General Object Graph in accordance with certain embodiments of the invention;

FIG. 3 illustrates a small example Object Graph according to the Metamodel of FIG. 1, in accordance with certain embodiments of the invention;

FIG. 3 illustrates a small example Object Graph according to the Metamodel of FIG. 1, in accordance with certain embodiments of the invention;

FIG. 4 illustrates a relational database schema for persisting the General Object. Graph, in accordance with certain embodiments of the invention;

FIG. 5 illustrates a UML Class Diagram for datatypes in the General Object Graph, in accordance with certain embodiments of the invention;

FIG. 6 illustrates an Internationalized String in XML, in accordance with certain embodiments of the invention;

FIG. 7 illustrates an example of Cascading Permissions in accordance with certain embodiments of the invention;

FIG. 8 illustrates a data browser for a General Object Graph in accordance with certain embodiments of the invention;

FIG. 9 illustrates a Sample Context menu, i.e. a right-click menu, for an Icon which points to an Object in accordance with certain embodiments of the invention;

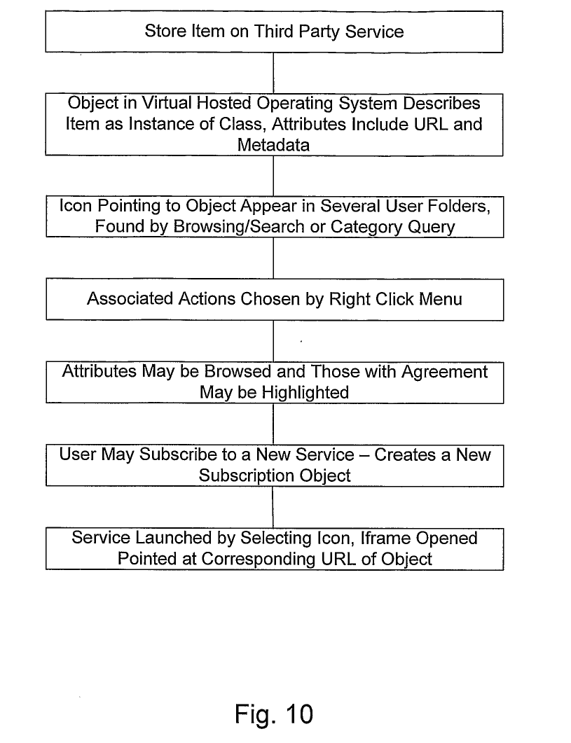

FIG. 10 illustrates a Use Case in accordance with certain embodiments of the invention;

FIG. 11 illustrates a flow chart of a method of accessing a third party service with a Federated General Object Graph according to certain embodiments of the invention;

FIG. 12 illustrates a UML class diagram for matching services with objects and actions—the classes shown are in one embodiment implemented within the General Object Graph of FIG. 1, in accordance with certain embodiments of the invention;

FIG. 13 illustrates an Alternative Metamodel for General Object Graph with methods in accordance with certain embodiments of the invention;

FIG. 14 illustrates a general architecture for a second embodiment of a federated object graph in accordance with certain embodiments of the invention;

FIG. 15 illustrates a sample navigator specialized on one Class of the Federated General Object Graph in accordance with certain embodiments of the invention;

FIG. 16 illustrates a user interface for a directory which may also be applied to a data source directory in accordance with certain embodiments of the invention; and

FIGS. 17A and 17B, which together form a single FIGURE, illustrate a UML class diagram for matching services with objects and actions according to certain embodiments of the invention.

### DETAILED DESCRIPTION OF THE PREFERRED EMBODIMENTS

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

### GLOSSARY

Unless the context determines otherwise, when the following terms appear with a leading capital herein, the following meaning is intended:
Adapter A mechanism, usually implemented in software, to expose a more proprietary API as a more standardized API and possibly to add metadata about the API.
AID Association ID—a unique identifier for an Association Concept
API Application Programming Interface (for automated access to some functionality)
Attribute A Concept which is attached to an Object to tell us something about the Object—may contain one or more values which should correspond to the type specified by the Association—Values may be a data type (number, string, etc.), or another Object.
Attribute Query A Query which specifies the Values of a specific Attribute of a specific Object.
Association A Concept which attaches to a Class to tell us what Attributes will be appropriate to Objects which are Instances of that Class and the Type of those Attributes (which might be Simple—i.e. a data type like integer, string—or Composite—i.e. Objects in another Class).
Category Depending on context, may be used as a synonym for Class.
Class A collection of Objects which have common Associations. In a preferred embodiment Classes are themselves special cases of Objects.
Class Query A Query which starts with all the Instances of a Class.
CLASS A special instance of Class such that every Object which is a Class (except for OBJECT and CLASS) are instances of this Class.
Client Software code downloaded to or installed on a user's computer (preferably running in the browser) for implementing the object navigation user interface and optionally signing-in, mounting data sources, embedding applications which utilize the general object graph and other user-facing features
Composite Association/Attribute/Value An Association whose type is a Class and the specific Attributes and Values which instantiate that Association (so that their Values are Objects).
Concept One of the ‘metaclasses’ of the Metamodel
Data source A source of data, typically a database often from a Third-Party Service provider, preferably data which may be mapped to object-oriented data, preferably available over the Internet using an API which preferably uses HTTP
Directory A listing of resources such as data sources (often with metadata, organization into categories, tags, user ratings etc.)
Extends An optional relationship between a first Object and a second Object which both refer to the same real work item.
File Object An Object that points at a File (usually a File hosed on the Web) and may provide metadata for that File
Federated General Object Graph Several object graphs hosted at different third-party service providers and provided with a common API and common navigation single sign on, and optionally the ability to search and query across them, in accordance with certain embodiments of the invention
Folder An Object which aggregates other Objects (or Icons which point at other Objects). Each Folder Object is an InstanceOf a Folder Class which has an Association (say FolderContents) of type Icon or of type OBJECT with no maximum cardinality metadata. A Folder may optionally be restricted to a specific CLASS for example the Folder with caption My Pictures may be restricted to pointing (directly or via Icons) at Objects which are Instances Of
General Object Graph A persistent object graph interacting with many users with a schema (classes and associations which may change at runtime (i.e. without programmer intervention and without restarting the system), in accordance with certain embodiments of the invention
Icon A graphical element which points to an Object. In a preferred embodiment many Icons may point to the same Object
IID Item ID—synonym/alternative for OID
Internationalized String A set of translations of a string which share the same meaning.
Item Sometimes used as a synonym for Object and sometimes used to describe the real world thing the Object relates to.
IText An object oriented class in a client-side web object oriented programming language such as JavaScript or OpenLaszlo (www.openlaszlo.org from Laszlo Inc. of San Mateo, Calif.) each instance object of which is responsible for displaying one Internationalized String in the language selected by the user from time to time.
InstanceOf/Instance of: A Concept which relates an Object to the Classes it belongs to. (Occasionally the term instance of is also used for an Attribute and the Association it belongs to). Strictly speaking ‘InstanceOf’ is the Concept which directly declares that an Object O is an instance of a Class C, whereas ‘instance of’ is the derived relationship which includes the implicit instance of relationship between O and all the subclasses of C (although sometimes the context will determine which meaning is intended).
Metamodel A model which specifies which Concepts comprise the General Object Graph and how they are related. This is called a Metamodel since the General Object Graph itself contains model concepts such as Class and Association.
Method An optional concept describing actions typical of the Objects in some Class
Method Implementation A specific realization of a Method, optionally offered by a specific service provider.
Object A unit of structured data similar to the well know Object Oriented Programming Language concept of object.
OBJECT A special Class which every Object (except CLASS and OBJECT) are instances of.
Object Icon A Client side class which implements an Icon including the image, caption, context menu, hot keys, listening for changes.
Object Graph A set of data objects including attribute values that point from one object to another
OID Object ID—a unique identifier for an Object. In a Federated General Object Graph this will typically include a service provider or data source identifier, an account identifier and an object identifier
Query A structured way of searching the General Object Graph
S3 The Simple Storage Service currently offered by Amazon Web Services Inc. of Seattle, Wash., which persists objects resembling files in a file system.
SimpleDB The Simple Database Service (previously called SDS) currently offered by Amazon Web Services Inc. of Seattle, Wash., which persists and indexes SimpleDB Items each of which may include multiple name/value pairs.
Server Depending on context often refers to the Web server, or application server, including the running instance of server code
Session A series of Client-server communications all of which rely on one authentication event (such as a user entering a username and password) and which are linked back to that authentication by a cookie or by a session code (which might be transmitted using URL redirection or as a parameter in an HTTP POST).
Simple Association/Attribute/Value An Association whose type is a datatype like String, Integer etc. (not a Class) and the specific Attributes and Values which instantiate that Association.
SSO Single sign-on—one system automatically authenticating a user to another system without the need for the user to perform a second login operation
Terminal A computer or other device which can run an Internet browser capable of running the Client software of the hosted operating system.
Third-Party Service A service offered by a third party over the Internet to users of a Virtual Hosted Operating System—the third party services are offered and delivered independently of the Virtual Hosted Operating System but are coupled to the Virtual Hosted Operating System for the purposes which may include service discovery, service launching, visual embedding of the service in the desktop, billing, communication (e.g. alerts) from the service to the user via the desktop.
User A person (or optionally a system) who is registered to use the Virtual Hosted Operating System (and typically has their own Virtual Computer).
User Vote If an Association (with maximum cardinality 1) is marked as a User Vote then for every Attribute instantiating that Association, instead of having a single value all users vote on what they think the Value should be.
Variable Sometimes used to describe the fields of Concepts according to the Metamodel—e.g. the cardinality of an Association (whereas the term Attribute is mostly reserved for those Attributes captured as Attribute Concepts within the General Object Graph).
Value A Concept giving the actual Value of an Attribute (e.g. the ‘Author’ Attribute of the Object ‘Alice in Wonderland’ has value ‘Lewis Carol’)
Virtual Computer (VC) A user's account on the hosted operating system—the account data combined with the Client code appears to the user just like a virtual computer (desktop, applications, data etc.) which is accessed through any browser.
Virtual File System A file system in which each of the Objects is in fact a pointer to file which is physically hosted by one of a plurality of service providers who host tiles; the pointer includes specific information about the type of the file so that it can be associated with appropriate hosted editing service (e.g. if the file is an image it can be edited with hosed image-editing software).
Virtual Operating System An operating system which does not physically run the applications which the user launches from it—instead those are run by direct interaction with a Third-Party Service providers but still coupled to the operating system in terms of the fact that they are launched from the operating system, the user may be authenticated by the operating system, the applications are visually embedded in the operating system desktop and the application may communicate alerts and other communications to the user via the operating system
Virtual Hosted Operating System A combination of the concepts of a Hosted Operating System and a Virtual Operating System. This novel combination utilizes the fact that the new concept of a Hosted Operating System lends itself to virtualization in a way which a Local Operating System did not.
Vote Value A Value which a specific User provides for an Attribute which instantiates a User Vote Association—i.e. this is a specific user vote for a Value where multiple users are invited to vote on the value.

### Detailed Description of a First Preferred Embodiment: General Object Graph

The concept of an Object Graph is known to those skilled in the art from Object Oriented programming languages such as Java from Sun Microsystems Inc., C++ from Microsoft Incorporated of Redwood Calif. and from object oriented relational databases such as those from Versant Corporation of Freemont, Calif. An Object Graph represents some real world entity or data entity. Classes within the Object Graph provide templates for groups of objects which are related. Classes have Associations which are templates for the Attributes of their Objects. The Attributes are named and relate Objects to other Objects or to data values.

A Class denoted C1 may be marked a Subclass of a Class denoted C2 meaning that every Object that is an instance of C1 is implicitly an Instance of C2 and every Association of C2 is implicitly Inherited by C1.

Object Graphs are usually limited in scope to specific business domains. Their Classes are usually determined at design time and change rarely. These rare changes typically occur only when a new product version comes out. Some aspects of an operating system such as the File System are generally outside the scope of any Object Graph, since the File System does not support links between Files and other Objects. In one embodiment, the present invention enables an Object Graph which exhibits additional flexibility to known Object Graphs and which is applied to a far broader range of tasks than traditional domain-specific object graphs. We there refer to this as a General Object Graph.

A General Object Graph may be a standalone system, or an infrastructure used by other applications or part of some broader “home application” which combines the General Object Graph with other functionality optionally including a file system and domain specific applications like a contact manager, calendar, customer relationship manager system, database of locations or other application program.

In one embodiment the General Object Graph is embedded in a Virtual Hosted Operating System which provides a desktop, applications and file system all in a Web browser. With some novel extensions the General Object Graph can play a key role in the Virtual Hosted Operating System. The idea is to have a single object graph telling us about concepts in the real world which are of common interest to multiple applications. The same single General Object Graph is to be accessed by many users, many applications and multiple infrastructure aspects. For example a Virtual Hosted Operating System can use it also for the file system and services directory. Even so, in one embodiment large volumes of Objects which are very specific to a single application are excluded for performance reasons.

Examples of the Classes of Objects that might be included in a General Object Graph are:
Real world Objects;
   Person and their relationships;
   Legal entity (company);
   Item/product (both generic e.g. a model number and a specific instance i.e. a specific serial number);
   Place (e.g. a city, address);
   Time;
   Financial, e.g. a bank account or credit card;
Hosted files at third-party hosted file service providers, e.g. a specific spreadsheet at Google Docs & Spreadsheets;
Service offerings, e.g. the Google Spreadsheet service;
Specific service subscriptions, e.g. account with Amazon.com;
A URL, e.g. a bookmark;
Shortcuts to other Objects; and
User reviews of other Objects

The same General Object Graph can address the following goals:
Provide an object graph which captures and share structured human knowledge effectively—by capturing Objects from different walks of human life, their attributes and interrelationships
Provide rich interoperability between applications, including, but not limited to:
   Drag-and-drop of real objects such as a book, address, person, credit card from one application to another (e.g. a credit card from a banking application to a shopping application or a person from a contacts application to an Internet telephony application—see below)
   Cross-referencing of data between applications via a common master data
Provide a file system which supports
   Virtualization of files across different storage services
   Sharing of files between user groups
Dynamically match service providers with service users based on objects (such as files) which the services relate to.

### Overall System Architecture

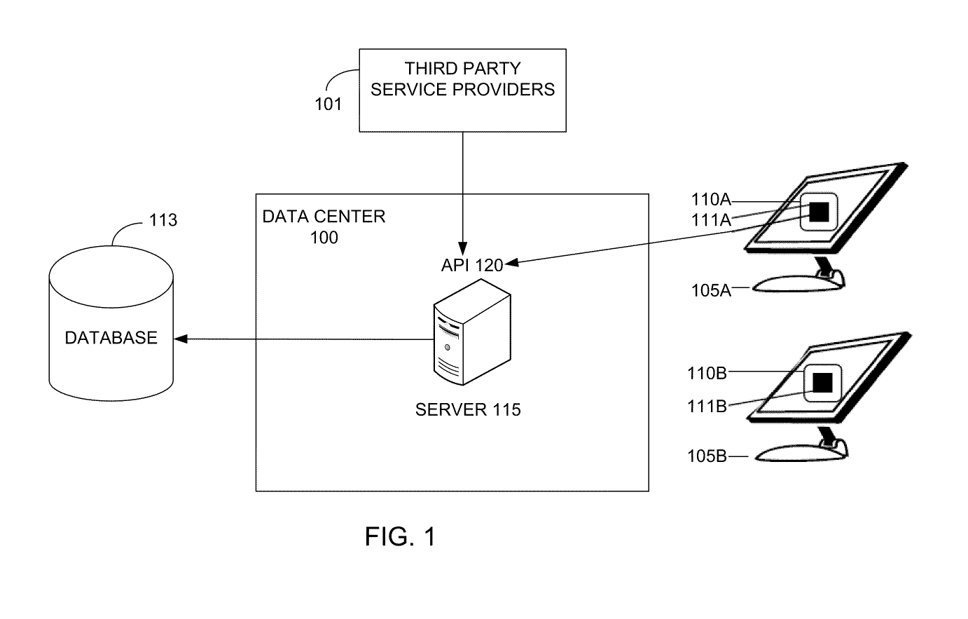

FIG. 1 illustrates a high level system architecture for a General Object Graph in accordance with certain embodiments of the invention comprising a data center 100 (which is a collection of computing resources not necessarily in one physical place), a plurality of third party service providers 101, a database 113, and a plurality of terminals 105a, 105b, generally 105. Data center 100 comprises API 120 and a Server 115 running a Virtual Hosted Operating System Server code 116 where the virtual hosted operating system is just one non-limiting example of a web application in which the General Object Graph functionality may be embedded.

Multiple users interact with the system using “terminal” 105a, 105b, respectively, each capable of running software which may be a PC but also a mobile phone, set-top box or other device. The user interacts with the system respectively using a Client 111a, 111b, generally Client 111, which might be installed software but which is preferably an interactive web page downloaded from data center 100, or a different data center, and running in a Web browser 110 on terminal 105. Client 111 is in one embodiment coded as a sequence of HTML pages generated server-side, i.e. at data center 100, using one of Java Server Pages and Microsoft Active Server Pages, without limitation. In another embodiment Client 111 is constituted of software code that runs in browser 110 using, without limitation, Flash, Javascript+DHTML (known as AJAX), Java applets, ActiveX or a higher level Web programming language such as OpenLaszlo.

A General Object Graph 114 is persisted in database 113 which may be a relational database, object database, or Amazon SimpleDB. Using the principal of a 3-teir architecture, the business logic for the General Object Graph is implemented in one or more server(s) 115 which exposes the business logic using API 120 which preferably is exposed over HTTP optionally using the principals of Representational State Transfer (REST) or a remove procedure call style such as XmlRPC or alternatively SOAP.

Third party service providers 101, which may or may not be technically and commercially related to the provider of General Object Graph 114 and the data center 100, provide applications which read and optionally write specific classes of objects relating to their domains to General Object Graph 114. They access General Object Graph 114 through API 120. Optionally, third party service providers 101 utilize a different API to the API used by the client 111.

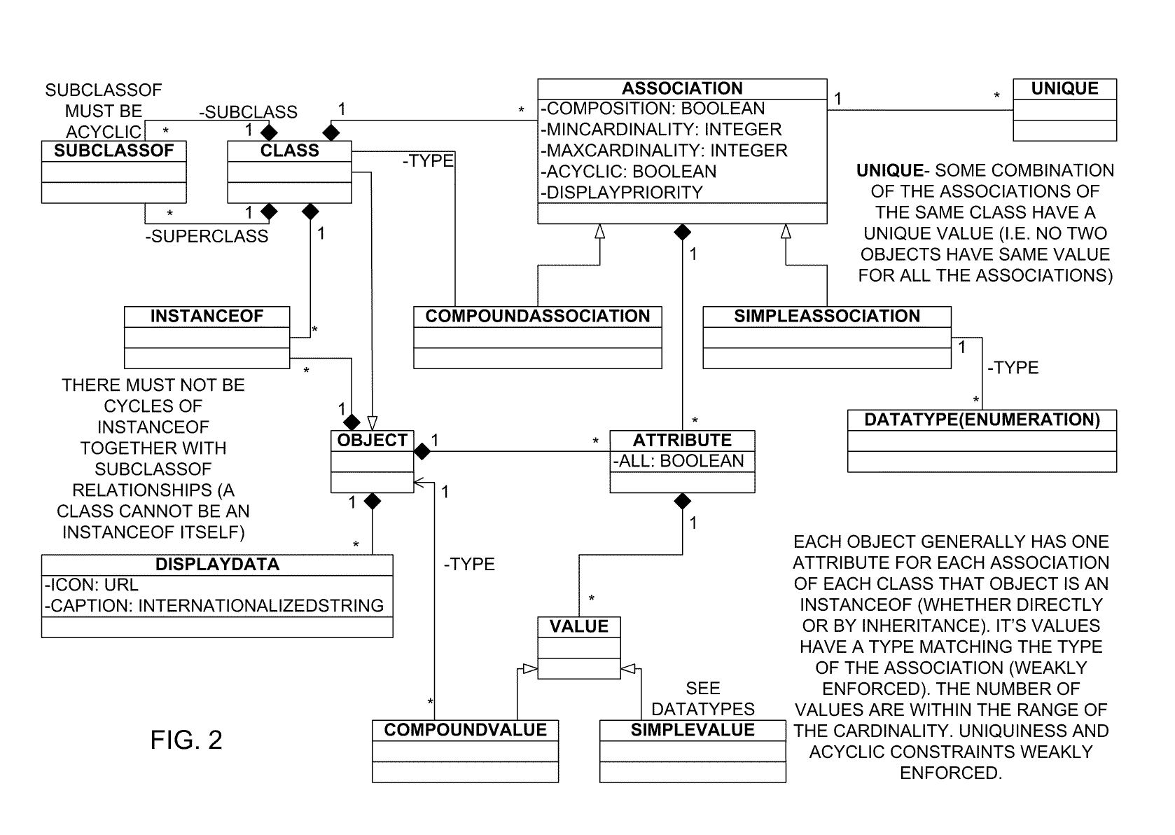

FIG. 2 illustrates a UML Class Diagram Metamodel for General Object Graph 114 of FIG. 1, in accordance with certain embodiments of the invention. The description below focuses primarily on the differences between a standard object oriented Metamodel, as implicit in the specification of an object-oriented programming language or the Object Management Group United Modeling Language [UML] standard which has an explicit Metamodel specified in the Object Management Group MOF standard, known to those skilled in art, and the expanded object oriented Metamodel of the present invention.

Objects are the central Concept in this Metamodel. An InstanceOf relationship relates Objects to the Classes they belong to. In contrast to Objects in accordance with most prior art Object Oriented metamodels, an Object in accordance with a principle of the current invention may belong to multiple Classes because this happens with real world objects. For example, a particular person may belong to a Class known as Engineers and a Class known as French citizens. Classes are related by Subclass relationships creating a Directed Acyclic Graph (DAG). An Object which is an InstanceOf a Class is implicitly an Instance of every Superclass of that Class. Therefore the function “Subclass-of” is also known as “Inherits-from”. In accordance with a principle of the invention, a Class is itself a special kind of Object and a Class may be an Instance of a Class. This contrasts with Object Oriented models of the prior art.

A Class has Associations. These provide a template for the Attribute of the Instance Objects of that Class. An Association may be Simple and have a datatype selected from, among others, integer, Boolean, and date. In another embodiment an Association may be Compound in which case the type is itself a Class. Thus, in a non-limiting example of an embodiment of a Compound Association, a Class “Person” has an Association “father” and the type of that Association is “Class Man”. Associations may have minimum and maximum cardinality and a combination of Associations may be marked as Unique, i.e. no distinct Objects may share values for all such Associations.

The Objects have Attributes—generally one for each Association of each Class which the Object is an Instance of, although this restriction need not be strongly enforced. The Attribute has Values and the number and type of Values preferably follow the type of the relevant Association, although this restriction need not be strongly enforced.

Particular Objects exhibit special DisplayData attributes—giving the icon graphic and caption for displaying it.

It is helpful to define two special Class Objects (whose name is written in all-capitals to distinguish these special Class Objects which are within the graph from the Metamodel Concepts they correspond to):
OBJECT: This is special instance of Class. Every other Object besides OBJECT and CLASS are implicitly an instance of OBJECT. Every Class implicitly inherits from OBJECT so that OBJECT is the root of the Inheritance DAG.
CLASS: This is a special instance of Class. Every other Class besides CLASS and OBJECT is implicitly an instance of CLASS. CLASS inherits from OBJECT.

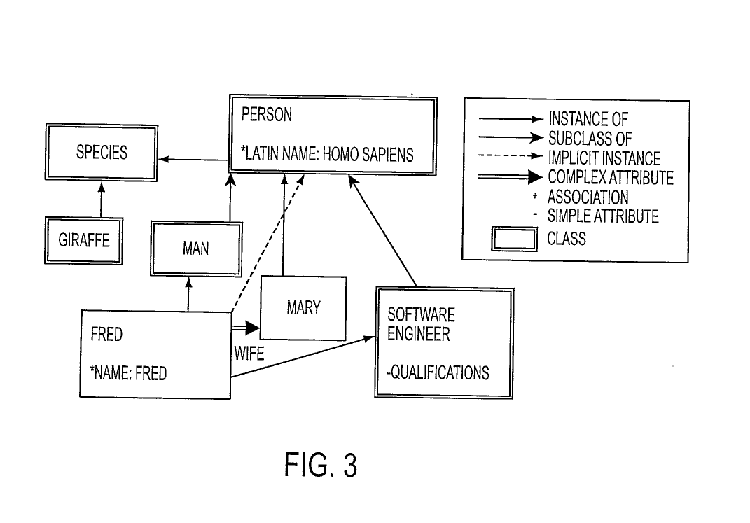

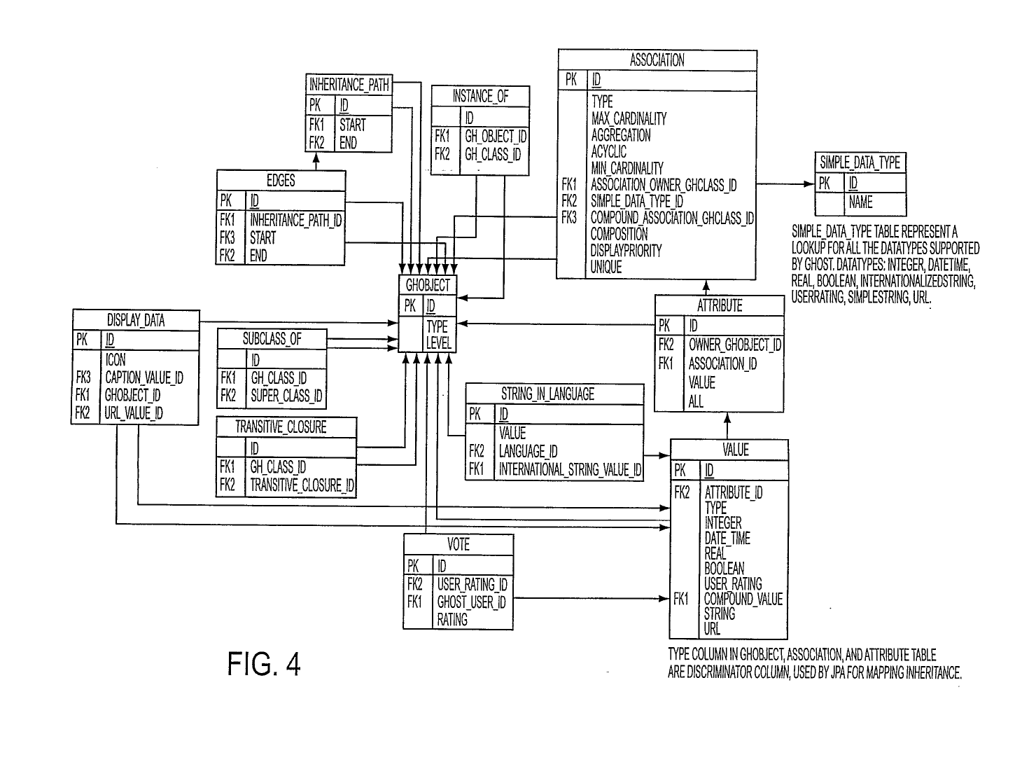

A small sample graph is provided in FIG. 3. Note how Giraffe is a Class (whose Instances are the specific Giraffes like Jerry the Giraffe) but it is itself an Instance of the Class Species.

An aspect of the Metamodel of the present invention is that the ‘schema’ concepts—Class, Association and SubclassOf can preferably change at runtime and are not hard coded as in most object-oriented systems.

According to a preferred embodiment of the present invention the General Object Graph includes Associations which are ‘Simple’ in the sense that they point at dataypes instead of other Classes and the corresponding Attributes take primitive values instead of pointing to Objects.

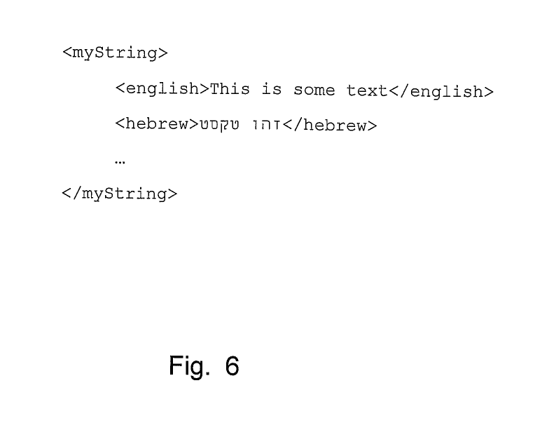

FIG. 5 shows a class diagram for the datatypes according to a preferred embodiment. Those skilled in the art will find it straightforward to persist this class diagram e.g. using object-relational mapping and to extend it with other datatypes known from programming languages.

Two data types require special mention, User Ratings and Votes, which are particularly applicable for instances where multiple users collaborate, or share, a joint resource. In such an embodiment, there is often a need, or a desire, to rate the resource and show the ratings to various users. For example the rating of a movie is advantageously established by averaging multiple user ratings or movie-of-the-year is advantageously established by allowing users to vote on the value (being a composite value which points at specific Objects of Class movie, say).

User Ratings is a value which is comprised of an average of user votes. For examples a user may choose a rating between 1-5, for example by selecting one to five of five stars in a user interface of Client 111. In a preferred embodiment each vote is stored including the userid of the voter, in order to prevent duplicate votes by the same user and all of them are associated with a single User Rating value object which has methods for calculating the average which is the value then displayed.

Alternatively a more general scheme of User Votes is possible which is not limited to 1-5 ratings. In this scheme every Association has a binary variable indicating if it is a User Vote or not (not shown in the Metamodel of FIG. 5). Preferably only an Association with maximum cardinality 1 (i.e. single-Values) may be a User Vote.

For any Attribute instantiating a User Vote Association, the Attribute will not have a normal Value but instead a number of Vote Values will be provided by users. Whenever the Attribute is shown to a user who has not yet voted on that specific Attribute, they will be invited to enter a ‘vote’ which is simply a Value (Simple or Composite) of a Type which is appropriate to the Type of the Association.

To implement this, preferably all Vote Values are persisted in a single relational database table or one Amazon Web Services SimpleDB domain although alternatively a separate table or domain may be used for each User Vote Association. Each Vote Value is preferably persisted with the following data:
ID of the User who cast the vote (might be the IID of the Object representing that user—used to block double voting by the same User);
The Vote Value;
The ID of the Item being voted on;
The AID of the Attribute being voted on (the IID and AID together uniquely determine the Attribute); and
Optionally the time of the Vote.

The Attribute of a User Vote Association does not itself need to persist any Value since those are available in the Vote Value persistence. However to increase performance, preferably the Attribute keeps some statistical data such as:
For a User Vote Association of Simple numeric type, a total and count of votes can be kept so that an average can be calculated without querying the Vote Value persistence.
For a non-numeric type (e.g. a Composite type—say a PersonOfTheYear Association whose type is Person) the Attribute may cache the leading values and the number of votes associated with each. (When a vote is cast for one of those values the count can be updated directly; when a vote is cast for a different value a query is required to test if that value now has enough votes to displace the third position.)

### Internationalized Strings

Two alternative preferred embodiments are described for persisting Internationalized Strings in a relational database (or by extension in another data persistence solution such as SimpleDB) so that Internationalized Strings which are Values in the General Object Graph may be persisted. In both of them each string has a unique identifier which might be a unique number and/or a more descriptive text key such as title-for-the-logout-warning-alert or more preferably a string of identifiers creating an implicit tree structure such as desktop-strings/alert-strings/title-for-the-logout-warning-alert.

According to a first embodiment one table (or file or Amazon Web Services SimpleDB Domain) has a row per string which includes:
Internationalized String identifier;
Language identifier, preferably one of a foreign key to a language table and the language name;
String, i.e. a translation of the given string in the given language;
Optional metadata for the Internationalized String, which in one non-limiting example comprises a description of its meaning and use; and
Optional metadata of the editing, which in one further embodiment comprises an identifier of the creator/editor of the Internationalized String, a date and/or time of creation/editing and comments thereto.

In this first embodiment there is optionally a second table which lists the Internationalized String identifiers and in that case the Internationalized String metadata moves to the second table.

In a second embodiment there is one Internationalized String table which lists the Internationalized String identifiers and metadata and there is one table per language which contains columns for Internationalized String identifiers and the translation String.

Preferably Internationalized Strings are transmitted from Virtual Hosted Operating System Server code 116 to Client 111 in one of two ways:

In the language of the user's choice, the user's choice being a parameter for the Client 111 request to receive an Internationalized String from Virtual Hosted Operating System Server code 116; or

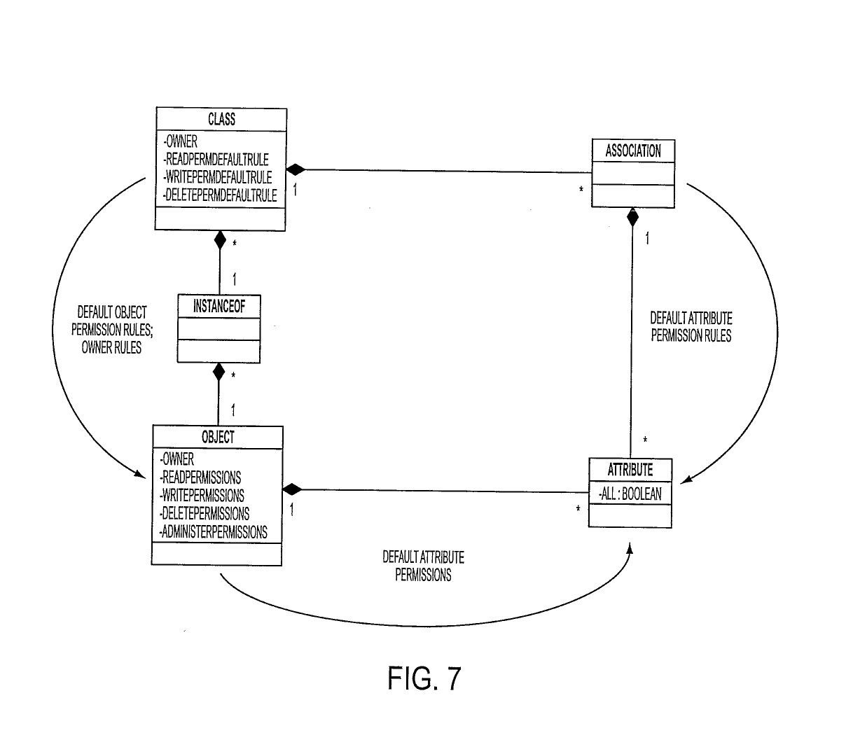

All the translations at once e.g. in an XML element of the general form as shown in FIG. 6.

As well as using Internationalized Strings for general attributes in the General Object Graph, e.g. for a description of a camera or review of a book, the same mechanism can be used to internationalize the graphical user interface of Client 111, as will be described further below.

### Persistence for General Object Graph

In one embodiment, General Object Graph 114 is persisted by an object-oriented database management system (such as those from Versant Inc. of Fremont, Calif.) since these are specifically designed to persist object graphs—however these typically do not support the full Metamodel desired.

In another embodiment, General Object Graph 114 is persisted by a relational database management system, with one table per class, and known strategies for capturing inheritance—however the schema will have to be changed at runtime which is not fully supported by most object-relational mapping tools and by the RDBMS itself.

In yet another embodiment a relational database management system is used with a schema reflecting the Metamodel (i.e. one table for all objects)

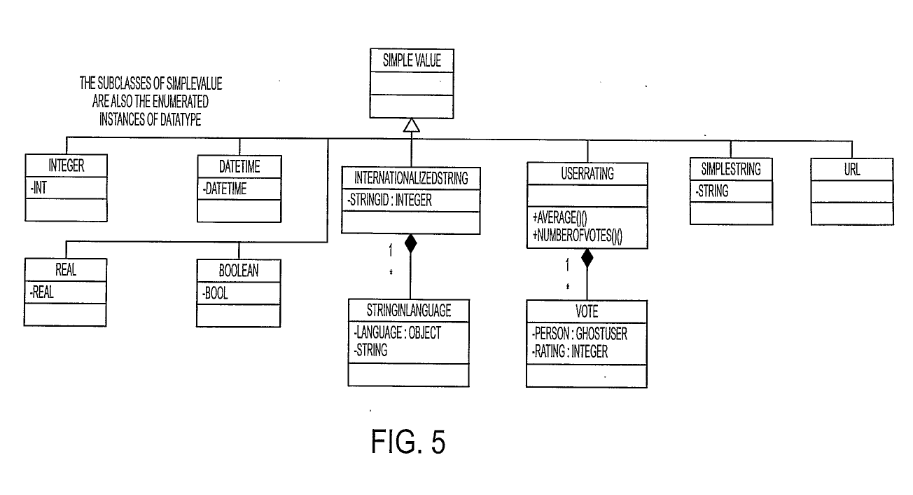

FIG. 4 illustrates a relational database schema for persisting General Object Graph 114 in accordance with certain embodiment of the invention. An alternative embodiment using Amazon Web Service's Simple Database (SimpleDB) service is described below.

### Versioning

In one embodiment of General Object Graph 114, a complete history is kept such that General Object Graph 114 can be reconstructed as it was at any moment in history. General Object Graph Concepts (the Metamodel classes) are dividing into two main categories from the versioning perspective: versioned and immutable concepts.

Versioned Concepts are Concepts that include variables subject to change from time to time, so that a version history for those variables is stored, while immutable object do not change, till they are deprecated.

Both of these categories, versioned and immutable are also subject to another classification: immortal and archivable. The second classification comes from the fact that some Concepts cannot necessarily be archived even after being deprecated, since other concepts point back to them so they may be referenced.

The specific concepts in the General Object Graph Metamodel of FIG. 2 are in one embodiment classified as follows:

| | Versioned | Immutable |
|---|---|---|
| Archivable | DisplayData, | Vote, Value, and all of it's |
| | StringInLanguage | subclasses. |
| Immortal | Association, | Object, Class, Subclassof, |
| | Attribute | InstanceOf |

In order to track changes in the concepts, accordance to an aspect of the invention we denote a particular type of event as an Edit Event. An Edit Event is preferably represented by the following parameters:
The user identifier of the editor;
The time of the edit; and
An optional comment.

Edit Events are therefore preferably persisted in a relational database table (or Amazon SimpleDB Domain) with four columns, the fourth being an arbitrary unique edit event identifier.

The following events will point to an Edit Event:
The creation of a concept;
Changes in a versioned concept; and
Deprecation of a concept.

Preferably a relational database for persisting General Object Graph 114 is adjusted to accommodate these versioning concepts as described below.

For every versioned concept there will be in addition to the concept identifier column a version identifier column which together form a composite key. Preferably the version identifier 0 will be reserved for the current version whereas version identifiers 1, 2, 3, . . . , n will denote historical versions (so that version 0 actually comes after version n).

Upon a change, the row of the master version 0 is first copied to become version (n+1), and then version 0 is updated with the new values.

In one embodiment such versioning is implemented by Aspect Oriented Programming a technique familiar to object oriented programmers. An Aspect is used to make sure that any change to a versioned concept (e.g. a call to a setter of an Object representing a Metamodel Concept) triggers a copying of the master version in this way.

Additionally every concept table preferably exhibits two additional columns for createEvent and deprecateEvent, In an immutable concept there is one row per concept and these columns denote when it came into existence and when, if at all, it was deprecated.

In a versioned concept each version of each concept has a row and these columns denote when that specific version became active and when it was replaced. The createEvent of version 1 denotes when the concept was first created and if the deprecateEvent if any of version 0 denotes when the concept was finally deprecated.

### Validity

In certain embodiments the following validity constraints apply to General Object Graph 114. Even so, optionally these are enforced weekly in that the graph may break validity rules and the system will simply highlight such breeches and encourage users to overcome them but will not prevent them. In one particular embodiment these constraints are applied in a ‘lazy’ manner meaning that when concepts happen to be displayed they are then checked for validity.
Foundation A class must not be an Instance of, or an Instance of an Instance of itself (or therefore of a Superclass of itself).
Acyclic inheritance There is no cycle of Inheritance relations between Classes
OBJECT Every Object except the special Objects “OBJECT” and “CLASS” are Instances of “OBJECT”.
CLASS Every Class Object except the special Objects “OBJECT” and “CLASS” are Instances of “OBJECT”.
Typing For every Object O: Every Attribute of O points to an Association which belongs to a Class which O is an Instance of and the value V of the Attribute must be an Instance of the Type of O For every Association A whose source is a Class to which O belongs (including via inheritance): There are Values V belonging to O and instantiating A and the Values of V are all Instances of the target of A and the number of values of V is more than or equal to A's min cardinality and less than or equal to A's max cardinality.
Association Constraints (indicated for specific Associations at runtime and then enforced on the instance Objects):
   Acyclic constraint: There is no cycle of attributes which all instantiate the same acyclic Association
   Unique constraint: There are no two Objects O1 and O2 which both instantiate the same Class C and which have the same Attribute Values for all the Associations of C which instantiate a group of Associations related by a Uniqueness Constraint.
   Aggregation: If an Object is marked as deprecated then any Object it points to through an Attribute which instantiates an Association marked as Composition, is also deprecated.

### API

In certain embodiments, API 120 provides access to General Object Graph 114 for Client 111 and optionally to third-party service providers 110 with methods such as the following:

getObject, getObjectStub, getAssoc, createObject, query, putUpdatedObject, createAssoc, isIntanceOf, isSubClassOf, getAttribute, getAssocs, setAttribute, addAthibuteValue, removeAttributeValue, deprecateItem, deprecateAssoc, addInstanceOfRelationship, addSubClassOfRelationship, removeInstanceOfRelationship, removeSubClassOfRelationship.

By way of example, the API method isInstanceOf is in one embodiment defined as follows
Parameters:
   OID item
   OID category
Returns: Boolean: is Object an InstanceOf Class (either directly or via inheritance)
Errors:
   Not authorized
   Parameter not valid (parameter name)—if item/category do not exist or do not start with O
   Service unavailable

### REST API

In another embodiment API 120 is an HTTP API preferably designed according to the style known as Representational State Transfer (REST). In this style each object will be given a URL according to its OID, e.g.

http://general-object-graph.com/{OID}

and related concepts may also have a URL e.g. an attribute

http://general-object-graph.com/{OID}/attributes/{attribute-name}

and the related classes

http://general-object-graph.com/{OID}/isInstanceOf

Relevant HTTP methods like GET, POST, PUT, DELETE may be used on these URLs in accordance with the principals of REST e.g. setting an attribute with:

POST http://general-object-graph.com/{OID}/attributes/{attribute-name}

and the attribute value in the body of the POST or using ?value=xyz

Queries may be attached to classes for example this might give all the instances of a class:

GET http://general-object-graph.com/{OID-of-Class}/instances

While this may be a query on some Associations assoc1 and assoc2 of the class (where the text inside [ ] must be URL escaped)

GET http://general-object-graph.com/{OID-of-Class}/instances?query=[assoc1=“5” and assoc2<“banana”]

In one particular embodiment, Object data is returned by API 120 in a format as:

```
<objectGraphItem deprecated=“false” owner=“public”
isaCategory=“false” IID=“GhNoteApp”>
    <instOf>
              <IID>app</IID>
            </instOf>
    <directInstOf>
              <IID>app</IID>
            </directInstOf>
    <displaydata icon=“notesIcon”>
    <caption><english>GhostNotes</english><french>GhostNotes
</french><deutsch>Ghostnotiz</deutsch></caption>
        </displaydata>
        <attribute AID=“description” sort=“simple”
type=“IntlStringXML”>
            <value>
                    <english>A simple editor for text note
files hosted by Ghost</english>
                    <deutsch>Ein einfacher Redakteur für
Textnotizenakten wird von G.ho.st ausgerichtet</deutsch>
                    <french>Un éditeur simple pour les
fichiers de notes texte heberger chez G.ho.st</french></value>
        </attribute>
        <attribute AID=“legalSvcProvider” sort=“simple”
type=“String”><value>Ghost Inc.</value></attribute>
        <attribute AID=“editorStorageService” sort=“simple”
type=“Boolean”><value>true</value></attribute>
        <attribute AID=“editsDataOfCategory” sort=“complex”
type=“String”><value IID=“GhNoteFileType”/></attribute>
        <attribute AID=“launchData” sort=“simple” type=“XML”>
            <value>
                        <GhostNotes
_S_launchMethod=“launchApp” _N_width=“400”
_N_height=“300”/>
            </value>
        </attribute>
    </objectGraphItem>
```

In one variation of this embodiment API 120 uses the WebDAV standard and optionally Categories may be treated as WebDAV collections.

### Alternative Persistence Using SimpleDB

An alternative approach to persistence instead of an RDBMS uses a hosted storage/retrieval/query service which deals with Objects which include name-value pairs. Amazon Web Services Structured Data Service (SimpleDB) available from Amazon.com Inc. of Seattle, Wash. in beta version, offers such a service and is used hereinto below to describe an alternative preferred embodiment of General Object Graph 114 persistence.

In SimpleDB the only datatype that is directly supported is a String. We therefore serialize all General Object Graph Simple Values together with their datatype (and other) metadata into XML Strings of the following format: <v>{serialized value}<t type=“{type code}”/></v>.

It will be appreciated by those skilled in the art that having the same precise string <v> to the left of all values will not impact the sorting of those values. It will also be appreciated that the use of XML allows extensibility to add more metadata—for example <v> may have more XML subtags to capture authorization for the Value, metadata about when the Value was created and edited, etc.

The type codes are in one embodiment as follows:
‘I’ for an Object ID (OID) in a composite Attribute
‘M’ for an Multi-lingual string ID
‘U’ for a URL
‘N’ for a number (see serialization of numbers below)
‘B’ for boolean followed by 1 for true or 0 for false
‘X’ for XML followed by XML
‘S’ for String

### Domains

In one embodiment the following SimpleDB Domains (which are vaguely parallel to relational database tables but not strongly typed in the same way) are used:
Objects
Associations
Inheritance Paths
Unique Constraints
Internationalized Strings
User Votes

### Objects SimpleDB Domain

According to one embodiment, every SimpleDB Item in this domain encapsulates one General Object Graph Object which may or may not be a Class—including all of its Attributes and Values.

The SimpleDB identifier of the Object is equal to its OID.

Each SimpleDB Item has some name/values pairs corresponding to the Metamodel Variables of the Object and some more name/value pairs corresponding to the Attributes of the Object.

### Metamodel Name/Values

The Object has the following Variables. It is to be understood that the Variables must be distinguished from the General Object Graph Attributes which have name=AID-. This is preferably accomplished by a leading underscore assuming that AIDs never start with a leading underscore.
_Owner=OID of the Object representing the owner (e.g. an Object in Class Person)
_Caption=ID of an Internationalized String (see Internationalized Strings SimpleDB Domain)
_Icon=URL or local resource name in Client code.
_IsAClass=(Boolean)
_InstanceOf=list of OIDs
   For a Class Object only:
_SubClassOf=list of OIDs

### Attribute Name/Values

In addition there is a list of name/value pairs each capturing a General Object Graph Attribute Value where the name is the AID of the Attribute and the Value is the value of the Attribute which is either an OID or a serialized data value. For one Attribute of type AID with multiple Values we put multiple (AID, Value) pairs with the same AID.
[AID]=[Value encapsulated as a String|OID for a composite attribute|ID of Internationalized Strings|ID of User Vote]

For example father=asdlkfhasdlkfh where father is AID of an Association and is a (unique randomly assigned) OID of the Object representing the father.

### Associations SimpleDB Domain

The SimpleDB Identifier is the AID

We have special name/value pairs representing the Variables of the Association Concept as follows:
_Caption=String or ID of Internationalized String
_Icon=URL or local resource name in Client code.
_OfClass=OID
_Sort=(Boolean Simple/Composite)
_Type=OID or datatype
_MinCardinality=(Integer)
_MaxCardinality=(Integer)
_Ordered=(Boolean)
_Repeat=(Boolean)
_UserEdit=(Boolean)

### Inheritance Paths SimpleDB Domain

We implement each path as an SimpleDB Item with three name/value pairs:
Start=Class OID
Finish=Class OID
Edges=[ist of (Start Class OID,End Class OID) edges

If required a transitive closure SimpleDB Domain (the use of which is described above) may be used where each Item has:
Start=Class OID
Finish=Class OID
Count=(Integer)

### Internationalized Strings SimpleDB Domain

We have one Object for each internationalized string:

SimpleDB Item identifier=Internationalized String ID
name/value pairs are
[language name]=(string)
   e.g.
   english=Shello italian=Sbon journo

### Versioning

In an embodiment in which persisting is accomplished in SimpleDB, in one further embodiment versioning is more easily achieved by versioning entire Objects and Associations. This method of persisting is contrasted with the more fine grained versioning scheme describe above.

To do this we create extra SimpleDB Domains for:
Edit Events
Historical General Object Graph Objects
Historical General Object Graph Assocs
Historical Internationalized Strings

When an Object/Assoc changes we copy the old version to an ObjectHistory and AssocHistory domain with a key of OID+Version#.

Every Object Assoc and their historical version get an extra attribute such as versionCreatedByEdit=[editEventID]

### A Navigator for a General Object Graph

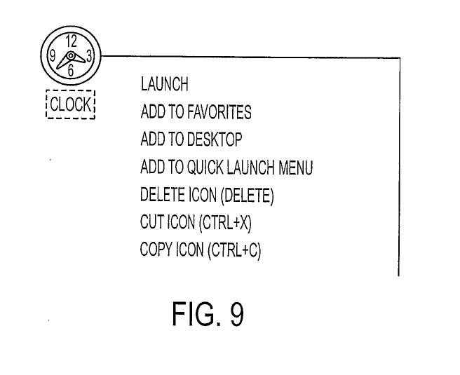

FIG. 8 shows a screen shot of a navigator for a particular embodiment of General Object Graph 114, denoted SNOOP 2701 embedded in a window on the background of a Virtual Hosted Operating System desktop with icons on left and taskbar at bottom. The navigator of FIG. 8 is in one embodiment an instance of Client 111 run within browser 110 on terminal 105.

Panel 2702 allows the user to define a query for Objects in the General Object Graph. Preferably two types of Queries are allowed:
A Category Query where the user selects a Class (e.g. by searching for its name or by navigating the Class inheritance hierarchy) and then specifies constraints on Associations such as values, ranges of values, or other logical constraints for some of the Associations of that Class (including Associations of the Superclasses) in order to narrow down which Objects of that Class will be shown (e.g. selecting Books and then selecting Publication-Date of 1990-1995 and Author containing the key word “Smith”). Preferably indirect Constraints are possible (e.g. selecting Books where the City of the Address of the Publisher is “New York”).
An Attribute Query, like the one shown in 2702, which starts not from an entire Class but more specifically from the Value of a specific Attribute of a specific Item (e.g. Friends of Adel as shown). In that case further filtration may proceed as above—by constraining the Associations of the Category which is the type of the Attribute (e.g. in this case Friends of Adel are of type Person so the user may constrain Associations of Person such as Age, Hair, Date of Birth).

Panel 2703, shown in its minimized state, shows a hierarch of Folders as familiar from most popular operating systems (or optionally several hierarchies such as the one starting with the user's own “My Objects Folder” and with a general public “Directory of Objects Folder”). When a Folder is selected it is equivalent to an Attribute Query on the FolderContents Attribute of the Folder Object selected—which will therefore show all the Icons/Objects in that Folder.

Panel 2704 shows a set of Icons 2705 pointing at Objects which are the results of the Query 2702 (or the implicity Query of selecting a Folder in 2703).

If a specific Icon 2705 is selected (e.g. by clicking, double-clicking or via a context menu) it may be shown in greater detail as shown at 2706. Simple Attributes may be shown in tabular format 2707. Composite Attributes may be shown using Icons like 2708 if they have a single Value or if there are many values an Icon like 2713 may represent the collection of Objects which are the Values of the Attribute. Clicking a single value Attribute 2708 may make it the subject 2706. Clicking on a set of Attributes 2713 may implicitly populate the Query panel 2702 with the appropriate Attribute Query in this case Books of Adel.

It is also possible to display reverse Attributes (not shown) e.g. Attributes which point back at the Object 2706—for example all the People whose Friend's Attribute includes Adel.

An unstructured search 2709 may search for Objects based on key words (which may be limited to key words in the Caption, or may include other or all Attributes of Type string).

A Folders Panel 2710 may list all the Folders where ContentsOfFolder includes the Object 2706.

A Categories Panel 2711 may list all the Classes which 2706 is an InstanceOf (which may include the direct ones only or also all the Superclasses of those—or the user may be presented with the direct Classes which the Object is an InstanceOf each of which may be the apex of a tree which the user can expand to see the Superclasses and Supersuperclasses, without limitation, which the Object is implicitly an instance of).

Some special “Anchor” Objects 2712 may be shows which may include the Object representing the user themselves, their main or home Folder, or other Objects that they may choose to place there.

### Icons

Preferably the navigator includes an icon representation for an Object which preferably includes:
A main icon which may be the display data of the specific Object or of its first Category;
Mouseover data showing the attribute values; and
A right-click context menu for accessing methods if supported, for navigating to composite values, for initiating queries etc.

Preferably Icons participate in drag-and-drop actions. For example dropping a first icon onto a second icon of category Folder would add to the contents attribute of the Folder the value of the first Icon's OID. Dropping a second Icon representing a Category would add that Category to the list of Categories for the Object which the first Icon represents.

### Client Object Cache

Preferably Client 111 caches copies of Objects that it reads from the server for quick navigation. Preferably results of Queries will not be cached (although it may be cached)—since a specific Object changes only rarely but the result of a Query is impacted by many Objects and will change frequently.

In one particular embodiment, a Cache is implemented using an OpenLaszlo dataset which contains an XML representation of the Objects that have been read. Preferably a ‘dictionary’ data structure is maintained on the Client so that Object data in the cache can be rapidly looked up by Object ID.

Preferably as well as the Object Data, the Client actually keeps an object-oriented object which encapsulates each Object in the cache (e.g. objects according to an OpenLaszlo class GeneralObjectGraphObject which point at the XML in the cache for an Object and which provide methods for manipulating the Object such as getCaption, getAttribute(AID), getInstanceOf and other variations and setters; preferably such an object can be further encapsulated in a graphical object which implements the icon which visually represents the Object).

### Application Interoperability Using General Object Graph

A use of General Object Graph 114 is to move structured data between applications, an in particular preferably applications launched from the same home application which might include a web desktop or preferably a full Virtual Hosted Operating System.

According to an aspect of an embodiment of the invention visual Icons represent pointers to Objects. Preferably these are implemented using a client-side programming language class denoted herein GeneralObjectGraphObjecticon. Therefore more than one application program may use the same class to represent Icons.

Preferably Icons may be dragged-and-dropped and/or copied-and-pasted between programs as a way of moving structured data, namely Objects, between programs. Alternatively as described elsewhere herein, preferably an Action may be chosen in respect to an Object which will automatically trigger an application or other Service.

In practice, preferably only the OID need be communicated between applications. The target application can use the OID as a key to query General Object Graph 114 for all Attributes (and Attributes of Attributes etc.) of the dragged Object.

Other GUI constructs may represent Object Containers being an interface of any GUI construct (or the underlying model in an MVC scheme) which is able to receive “drop”s of Objects (e.g. with a ‘drop’ or ‘addObject’ method).

Sample use cases include:
Dragging a person from a contact management application to an Internet telephony application to initiate a phone call;
Dragging a credit card to a shopping cart to pay for goods;
Dragging a product from one shopping application for another to compare prices; and
Dragging a product from a shopping application to a user's Folder to add it to the contents of the Folder for remembering for later.

Advantageously, by implementing the file system using General Object Graph 114 simpler actions which are known from operating systems in the prior art such as dragging-and-dropping files between folders are implemented as special cases of the more general drag-and-drop.

### Social Networking Using General Object Graph

A use of General Object Graph 114 is to help people find each other and initiate communication. This is achieved, in accordance with certain embodiments of the invention, without any change to the Metamodel by creating Associations which relate a User Class (or more generally a Person Class which may include information about non-Users) to other Classes.

For example there might be an Association StudiedIn which relates the User Class to a University Class. A User may create a corresponding Attribute to register which university they attended. Another user may Query to see who else attended the university they attended.

In another example, the Class Product may have a Composite Association OwnedBy of type the Class Person. As a result, Users can thus use General Object Graph 114 to find other people who share ownership of the same product—for example a camera which they want to discuss usage of.

Preferably General Object Graph 114 is coupled to a Service or Services which in one embodiment is a Third-Party Service from Third-Party Service provider 100, for communication between its users which might include instant messenger, e-mail, voice-over-IP and videoconferencing over IP. Preferably a user initiates such communication by right-clicking in the General Object Graph Navigator, as described above in relation to FIG. 8, on an Icon representing an Object which is an instance of a Person Class (associations Actions with Objects is described below) or drag-and-drop the Icon representing the person to the user-interface associated with the communications Service (drag-and-drop of Objects between applications is described above).

It will be appreciated that by combining General Object Graph 114 with an ability to instantiate communication, General Object Graph 114 takes on a new and unique role in enabling rich social networking around common interests, common geography common family links, and/or common history of people. The above is a non-limiting example of advantageous social networking according to an aspect of the invention.

Further any Association of type Person, or a subclass thereof, which has maximum cardinality more than 1 defines a group of users with something in common and these user may be invited to become a group for other purposes including, but not limited to: group communications, sharing privileges to access shared resources and/or sharing desktop preferences.

### Virtual File System

According to certain embodiments of the invention, files from multiple file system have their data represented as objects in General Object Graph 114 in addition to inside the file system. Advantageously, this allows richer object-oriented metadata for the files. For example a file representing say a photo may be represented by an object which has an attribute pointing at an object representing the photographer.

Further advantageously, files from different file systems from different service providers can all have metadata in a single General Object Graph 114 providing a sort of virtual file system.

### Use Case

Generally, prior art file systems allow logical units of data called ‘files’ to be stored on the same physical disk. Further they usually allow the files to be organized into a hierarchy of folders. Networked file systems allow files from more than one physical disk to be organized into the same folders. Links or “shortcuts” allow the same file to be referenced from more than one folder. What is common to these systems is that each file corresponds to some physical location on a directly accessible disk.

This approach is not appropriate for a user who wishes to work with files from many different web service providers (e.g. as part of a Virtual Hosted Operating System) across the Internet over which they have no physical control.

For example today a user may have photos stored on flickr.com by Yahoo! Inc. of Sunnyvale, Calif., spreadsheets stored on Google Docs from Google Inc. of Mountainview, Calif., and any files at xdrive.com from AOL Inc. These third party file hosting service providers each have exclusive control over the physical storage of the files they store. Yet a user would like to organize all of these files into the same set of folders. Also the user would like to apply actions to these files depending on their type, irrespective of the service provider.

For example a user may desire to take a photo file hosted by photo storage service flickr.com and another photo file hosted at xdrive.com and logically place them in a single ‘My photos’ folder. A simple hyperlink will not suffice because the user desires to perform specific actions such as ‘edit photo’ which are specific to the type of file in discussion.

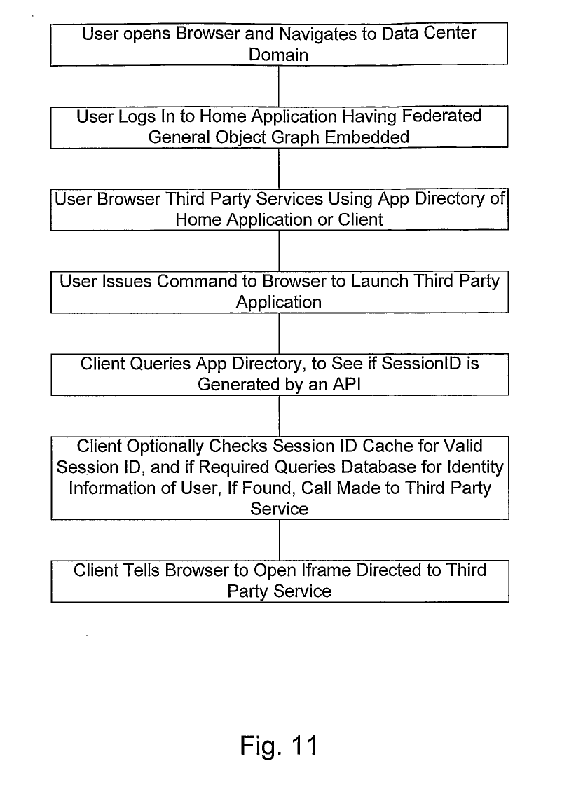

A detailed example use case is as follows as illustrated in FIG. 10:
A photo is stored on Flickr.com
An Object in the Virtual Hosted Operating System describes the photo, as detailed further hereinto below, using an Instance of Class HostedPhoto, which is a SubclassOf (inherits from) Classes HostedFile and Photo; Attributes include its URL at Flickr, and its meta-data including, but not limited to caption, owner and image resolution
An Icon pointing to the Object may appear in several Folders of a User (and other Users) such as My Pictures, My School Project, My Favorites
The user finds the Object by:
   Browsing/searching the Folder; or
   Doing a Category Query for Objects of type Photo
The user chooses an associated action of Edit via the right-click menu
The user is presented with a list of Objects of type Services, associated with Service Providers, which are able to provide the service of Edit on an object of type HostedPhoto.
   The user may browse Attributes of the Services such as cost and terms of service.
   Services with which the user has a prior legal relationship, such as a subscription, may be highlighted above others (or the user may select a default service provider for the Action of Edit on Objects of Class HostedPhoto)
The user may subscribe to one of the offered services and create a new Subscription Object
The user may launch the service in which case a new Window is opened and pointed at the corresponding URL (including a name/value pair to tell the target Service the OID of the particular Object it is acting on—in this case which hosted photo it is editing).

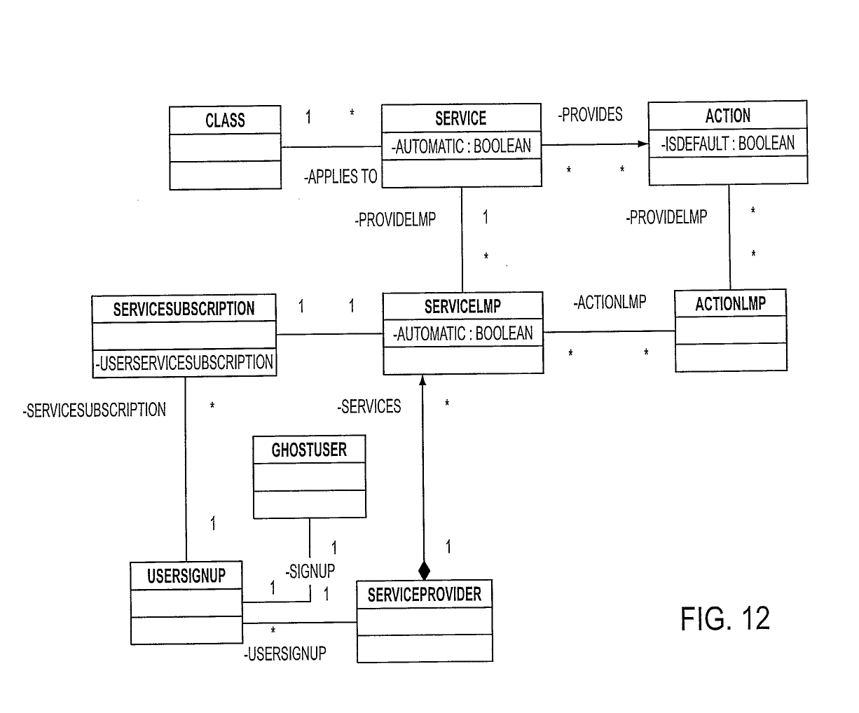

The virtual file system aspect of the invention may be understood by reference to FIG. 11, which illustrates an embodiment of a user interface in an embodiment of the virtual file system, which is an instance of Client 111 running in Browser 110. FIG. 11 exhibits a window titled “My Documents Explorer” divided into a left and right panel.

The left panel shows a hierarchy of Folders. The root folder is called ‘My Documents’ and is selected. The right panel shows Objects which are in the selected Folder.

These includes subfolders ‘favorites’, ‘quick launch’ and ‘desktop’. This user interface for viewing the folder hierarchy may be used instead or as well as the more general user interface in illustrated above in FIG. 8 for browsing General Object Graph 114 which also includes browsing of the Folder hierarchy.

The contents of the ‘My Documents’ folder shown in the right panel further includes:
An object ‘Yahoo URL’ which is a hyperlink to a web site—shown with extra ‘mouse-over’ details;
An object ‘Upload File’ which represents a generic file to be uploaded from the Client's desktop to a file storage service provider such as xdrive.com or a service provided by the Virtual Hosted Operating System service provider;
An object ‘My Note’ associated with a ‘note’ file Class and representing a note file type which is hosted by some service provider;
An object ‘Google Doc1’ which points to a file of Class ‘document’ and which happens to be hosted by Google Inc; and
An object ‘Mich photo 1’ which points to file of class image and which happens to be hosted by flickr.com from Yahoo! Inc.

The distinction from a physical file system will be appreciated. The different icons do not represent files with a known physical location. Instead they represent files which may be accessed through different third party services using different interfaces. Further the metadata in the Object is not just a hyperlink generic file metadata but is preferably highly structured metadata optionally including Composite Attributes which link the Object to other Objects.

Even so the user is able to interact with these files almost as if they were on the local disk. Advantageously the virtual file system of the subject invention abstracts access to files stored by different third party file storage service provider including:
Abstracting the fact that service providers use different user authentication schemes:
Abstracting the fact that service providers have different ways of representing files which are essentially of the same class (such as image, spreadsheet, document) and allowing the user to access actions which are appropriate to the class of file; and
Abstracting the fact that service providers use different protocols to access the files.

The mechanism for abstracting authentication is described elsewhere herein under ‘Single Sign-On’ and is further described in the above incorporated co-pending and co-filed patent applications.

The mechanism for abstracting the classes of files and the actions associated therewith are described elsewhere herein under ‘General Object Graph’—since in accordance with certain embodiments the invention is able to associate actions with classes of resources more broadly than only classes of file resources.

To abstract the different protocols to access the files, a common protocol or interface is preferably used. In one embodiment, file transfer protocol known as ftp defined by the Internet Engineering Task Force of Sterling, Va. is used. Where a third party service provider does not support the common protocol, an adapter may be hosted by the service provider of the Virtual Hosted Operating System within Virtual Hosted Operating System Server code 116. In one particular embodiment the adapter is a Java Servlet running on a Java Web Server with a Servlet Container such as TomCat from Appache. The adapter accesses the file from the third party service provider and makes it available using the common protocol. When such an adapter is used, the URL address listed for the third party service provider in the services directory will be the URL of the adapter.

Alternatively, multiple protocols may be supported and the services directory may list as an Attribute of a Service implementation which protocol is supported by each file storage service provider.

It should be noted that in many cases the third party file storage service provider also provides a file editing service. For example Google Inc. hosts spreadsheets documents and also hosts application software for editing the spreadsheets. In this case it is not necessary for the Virtual Hosted Operating System to access the physical file at all. In the case where the User desires to use the editing service from the same service provider, the editing service is preferably launched, e.g. in an iFrame window, and passed a parameter identifying the file to be edited.

If however the user desires to edit a file from one file storage service provider with an editor from a different hosted application service provider, the Virtual Hosted Operating System accesses the file using a common protocol or adapter and transmits it to the third-party hosted application service provider.

### Virtual File System Implementation Detail

While the Virtual file system may be implemented independently, it is instead preferably implemented using General Object Graph 114. In one particular embodiment:
A Class “Folder” is introduced into the General Object Graph with an Association FolderContents of type OBJECT and unlimited maximum cardinality—thus a Folder can contain any number of Objects of any type
Some further Classes and Subclasses are introduced for specific types of files like ImageFile (subclass RectangularImage, JPGImage), Spreadsheet, . . .
Some further Classes and Subclasses are preferably introduced for specific hosting types e.g. HostedFile with Subclasses HTTPHostedFile, FTPHostedFile etc.
Each User is preferably given an Object of type VirtualHostedOperatingSystemAccount which further preferably includes an Association MyDocumentsFolder pointing at a Folder created for that User when they register (they can then create their own SubFolders).
A Folder Explorer such as the one illustrated in FIG. 11, and described above, is implemented as part of the Client standard programming techniques—or the more general General Object Graph Navigator described below may also be used.
Some components such as a Save As dialogue are preferably introduced (utilizing the General Object Graph API described herein) to be used by applications within the Client 111 and Third-party applications from Third-Party Service Providers 101 which may want to save files to the file system.

While the Virtual File System of Client 111 can accommodate files hosted by Third-party Service Provider 101 and in fact Objects of all Classes, it is advantageous for the Virtual Hosted Operating System server 115 to include some storage for each user for uploading/downloading files from their local operating system. A user interface for this as part of a File Explorer is shown in FIG. 11, where the user selects New Uploaded File and then the Client 111 will: (a) create a new Object in the current Folder containing metadata for the file and a unique OID; and (b) launched a web form to allow the user to pick a file from their local operating system and upload it to the file system of web server or application server 115 where it will be stored e.g. in a folder with name equals to the User's user ID and with file name e.g. equal to the OID.

Preferably specific interfaces are created for various specific hosted file services. For example suppose there is a General Object Graph Class SupportedHostedFilesClasses and for every instance such as GoogleHostedSpreadsheet a menu item appears in the File Explorer “New Google Hosted Spreadsheet”. According to an Association of SupportedHostedFiles, GoogleHostedSpreadsheet has an Attribute pointing at some code or a URL of an adapter which is able to launch Google Spreadsheets with a blank new spreadsheet in an iFrame. When “New Google Hosted Spreadsheet” is selected, Client 111 creates a new Object of type GoogleHostedSpreadsheet in the current Folder and passes the OID to the adapter which returns Google's unique ID for the new spreadsheet using Google's API and this is added as an Attribute to the Object. The next time the Object is double-clicked, a second method of the adapter is called to open the existing spreadsheet based on Google's unique ID. In this workflow the request to create the hosted file originates in the Virtual Hosted Operating System Client but alternative adapters can help discover existing hosted files and create Objects to represent them in the General Object Graph in order to create an effective Virtual File System.

### Services Over the Virtual File System

In one embodiment services are overlaid over the virtual file system, the overlaid services being otherwise designed to work with a physical file system.

For example, a file transfer protocol (ftp) server product such as Apache FTP Server from the Apache Software Foundation is adapted to ensure that the calls it makes to a physical file system are replaced by calls to a virtual file system.

### Accessing Third-Party Actions

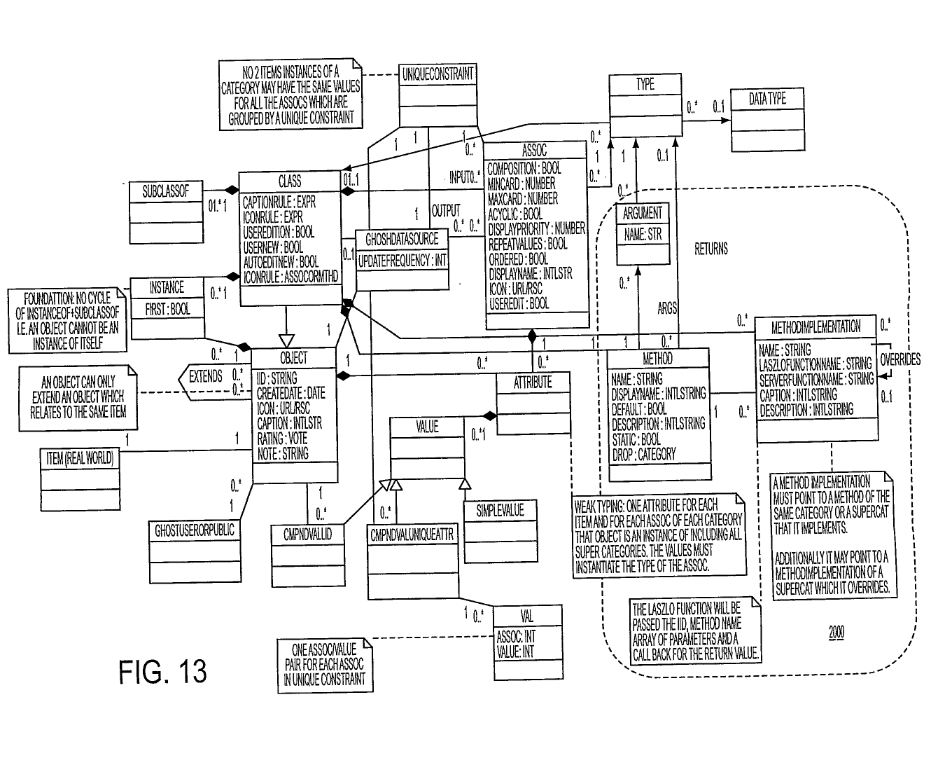

A system for matching files with editing services, and more generally objects and actions with service providers according to a preferred embodiment of the invention may be understood by reference to FIG. 12, which illustrates a UML class diagram for matching services with objects and actions, in which the classes shown are in one embodiment implemented within General Object Graph 114. The Classes shown are in one particular embodiment implemented in a hard-coded manner, for example using object-relational mapping known to those skilled in the art, and in another particular embodiment are implemented soft-coded as some of the Classes in the General Object Graph described above.

At the top of FIG. 12 there is the abstract concept of Service. Each Service is associated with Class in the General Object Graph, which is always an instance of the special CLASS Class. For example the Service ‘photo-editing’ may be associated with the class ‘Hosted Image File’, meaning that the service is pertinent to Objects of that Class. The abstract Service is associated with Actions which in this case might include New, Edit, Delete, View. Of these New may be marked as ‘Static’ in that it is not invoked on a specific object.

At the bottom we see that there are ServiceProvider. These are typically companies who offer services online, i.e. Third-Party Service Providers 101. A ServiceProvider may offer a specific implementation of a Service such as photo-editing and specific implementations of the associated actions. ActionImp has a template for accessing the action including at least a URL and a parameter name for passing the object identifier by for example HTTP GET or POST of the Object on which the Action is being invoked.

ServiceProvider typically offer Subscriptions which may often span multiple services. The system preferably tracks when a Virtual Hosted Operating System user signs up to a service provider for services. Preferably, a separate table keeps parameters associated with how to access a given service provider sign-in and actions, as described further below regarding Single Sign-On.

By adding methods to the General Object Graph Metamodel

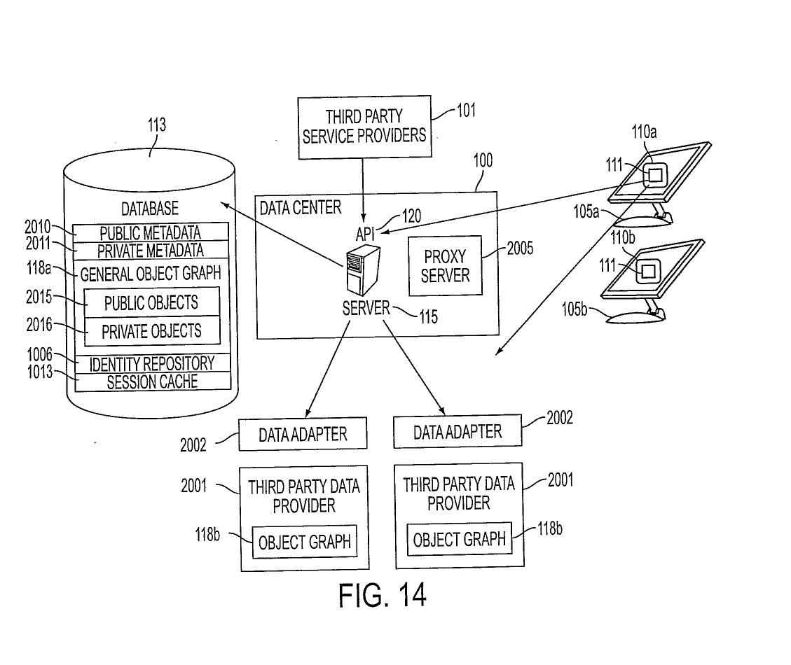

An alternative approach to matching actions and specific third-party service offerings to Objects is by extending the Metamodel as illustrated in FIG. 13, and with specific reference to callout 2000 thereof.

In the Metamodel of FIG. 13 every Class may further be related to any number of Methods (as an example a File may have a “view” and “edit” method and the subclass Photo may further have a “Print” method, while a Product may have a “buy” and “sell” method); the methods are now first-class concepts under the extended Metamodel.

A method may optionally take further arguments. For example the “bid” method on a Product may require a price number and the user asking to implement the method (e.g. by right-clicking on an Object's Icon to see all methods associated with the Object's Class including Superclasses) will be prompted to input values for the Arguments.

A Class also has MethodImplementations each of which implements some Method (of the same Class or of a Superclass) by providing a specific API method to be called (which may be a local method call in the Client [shown by way of non-limiting example as a Laszlo method], a remote call in the server, or direct to a third-party service-provider API). The MethodImplementation may override a MethodImplementation of a superclass which relates to the same Method.

By way of example:
Consider a Class Product in a General Object Graph;
Product had a Method Buy;
Product has a subclass MusicTrack;
Product has ImplementationMethods Buy-from-AnOnlineShop.com and BuyFromOldSchoolVendorInc relating to method Buy;
MusicTrack has an ImplementationMethod Buy-from-AnOnlineShop.com-for-immediate-download which overrides Buy-from-AnOnlineShop.com;
User has an icon in a Client representing a MusicTrack;
User right-clicks and sees a list of all relevant Methods (including inherited Methods) and selects Buy; and
A dialog pops-up asking user to select from Buy-from-AnOnlineShop.com-for-immediate-download or BuyFromOldSchoolVendorInc. User may be offered to “always do this choice” and metadata on each method implementation might be provided.

### Authorization for the General Object Graph

The goals of authorization is to provide a logical model from which we can determine in a useful, fair and secure way, who may:
read:
   discover the Object (i.e. in a query or navigation)
   read a specific Attribute (or possibly a specific Value)
   search
   query
write:
   add an Object to be an InstanaceOf a Class
   modify an Attribute
      add a Value
      change a Value
      remove a Value
deprecate an Object
change the owner
change the icon
change the caption

Additionally we need to know who is authorized to set and change permissions for the above.

### Principles of Authorization

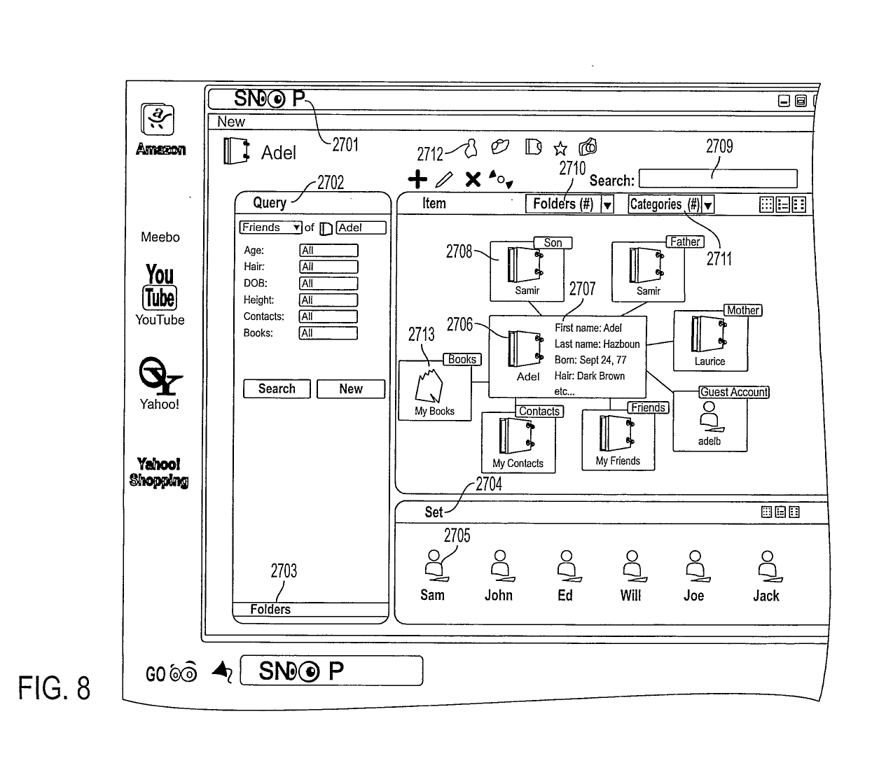

The principles of a model for cascading authorization according to the invention may be understood with reference to FIG. 7.
Ownership: Every Object has an Owner, and if not it is public domain. There are different schemes for the ownership of Items and these are preferably determined if the Object Instantiates certain special Ownership Categories, either directly or via inheritance.
Object Permissions
   Defaults: An Object will have default permissions rules for read, write, delete determined by the Class to be one of owner, owner's trusted group and public.
   Specific permissions: An Owner or administrator of an Object may override the defaults and set the specific permissions for any Object.
Attribute Permissions
   Defaults: Default read/write Permission for an Attribute is the same as the read/write permission for the Object
   Assoc-set Defaults: The Assoc may specify different default permissions for an Attribute. In one non-limiting example a social security number may be more sensitive than the rest of a Person Object
   Specific permissions: An Owner or administrator of an Object may override the defaults and set the specific permissions for any Attribute.

### Roles

The following roles interact with General Object Graph 114:
A registered User of the Virtual Hosted Operating System
More generally any Person—a person, even if they are not registered user of the Virtual Hosted Operating System, may be an owner of Virtual Hosted Operating System data
Virtual Hosted Operating System User (i.e. a computer, not a person)—either a Client 111 of a Virtual Hosted Operating System or a third party trusted system

### Transferring Confidential Information

An assumption according to the invention is that we may assume that once a user reads data there is nothing to stop the user from transferring this data to others. For example if user A is authorized to discover the OLD of an Object, and thereby see all Attributes with default permissions, they may choose to pass on the OID to another user. Preferably the Virtual Hosted Operating System will not try to prevent that because in real life too—anyone who is trusted with information must also be trusted to choose who they pass it on to.

An OID for an Object is a secret key to that Object. It is too long and random to guess. Preferably the OID for an object comprises a 128 bit random number generated using one or more of fine grained time, IP address, ambient temperature and other arbitrary varying data. Anyone who has an OID is assumed to have either discovered themselves based on legitimate permissions or to have received the OID from someone who discovered it legitimately and who had the right to pass it on.

### Attribute Permissions

Permission for an Attribute are determined based on a combination of:
ownership and permissions settings of the Object it belongs to;
rules of the Assoc it belongs to; and
specific permissions set by the Owner for the Attribute.

### Impact on Modeling

A model of two Categories, C and D, and an Association between them, should consider which direction the Association is based on, and this is based on ownership. An Association C->D will be controlled by the owner of the C-type Object. An Association D->C will be controlled by the owner of the D-type Object.

### Ownership Schemes by Class

The following special Categories preferably have hard-coded behavior which imposes restrictions on how the Instance Items are Owned. Other Categories may be Subcategories of these.
SelfOwned—every Object in this Class preferably must be owned by itself. Preferably Only Class Person should be a Subcategory of this
Owned—This Class preferably has an Owner Attribute which captures the real-world owner of the underlying physical object. The Owner of the Object preferably must equal the Owner of the Object, or a representative of the owner if a Legal Entity.
CategoryOwned—Every Instance Object of the Class preferably must have the same Owner as the Class, normally for system controlled Items.
PublicOwned—Every Instance Object of the Class preferably must have no Owner. This is the public domain.

In one embodiment a Disjointed Class constraint is added to the General Object Graph Metamodel to indicate that the above three Categories are disjointed—i.e. no Object may Instantiate more than one.

If none of these special Ownership Categories apply then preferably an Object will be Owned by its Creator who may also assign the Ownership to another.

Non-Limiting Example
Every Person will be SelfOwned
A Virtual Hosted Operating System Account will be CategoryOwned by the Virtual Hosted Operating System
A House will be Owned by the actual owner of the house, whether or not they are a Virtual Hosted Operating System User.
A Review will not have an Ownership Class and will be owned by its Creator
A Folder will not have an Ownership Class and will be owned by its Creator or public
A File on Virtual Hosted Operating System Storage will not have an Ownership Class and will be owned by its Creator
A Google spreadsheet will not have an Ownership Class and will be owned by the Creator of the General Object Graph Object who will be the Virtual Hosted Operating System User who does a single-sign in to Google and first creates a General Object Graph Object for the spreadsheet
A reference Object like a Country or Language will be CategoryOwned by The Virtual Hosted Operating System Modeling Team

Object ownership impacts modeling. Preferably Credit Card data is separated from Credit Card Account because the former is owned by the credit-card holder whereas the account is controlled by the bank.

### Object Permissions

An owner preferably sets permissions for an Object
Read Object: Discover (i.e. find Object and its OID in a Query or Search) and read Object Icon, Caption, Owner, InstanceOf and default Attributes (may be overridden for specific Attributes)
Write Object: Change Object Icon, Caption, Owner, InstanceOf and default Attributes (may be overridden for specific Attributes).
Delete Object
Administer Object: Implies read, write, delete+changing owner and permissions

The permissions are preferably ordered, i.e. each permission implies the permissions above it.

Each of the four permissions may be Owner/Trusted/Public or may be granted to a specific set of UserGroupings

These permissions are preferably set at three levels:

### Default Object Permissions

Barring any other settings, the permissions will be:
Read: Owner's Trusted Group
Write: None (i.e. only Owner)
Delete: None (i.e. only Owner)
Admin: None (i.e. only Owner)

### Class Defaults for Object Permissions

Every Class preferably determines the default permissions for the Items in that Class differently to the above generic defaults. For each of Read, Write and Delete, the Class preferably sets a default permissions pattern of:
Owner—by default only the Owner will be given this permission for Items in this Class
Trusted—by default Owner's Trusted UserGroup will be given this permission for Items in this Class
Public—by default only the Owner will be given this permission for Items in this

### Class

A Class inherits these from its Subcategories—it preferably inherits the strictest if there is more than one. If an Object belongs to more than one Class which sets default Object permissions, it will preferably inherit the strictest.

The default for Administer is preferably always Owner and preferably cannot be overriden by the Class.

### Specific Object Permissions

The Owner or anyone with Admin permissions may preferably change the permissions for a specific Object.

### Attribute Permissions

Attribute permissions may be determined in three levels:

### Object Default

If there are no specific permissions for the Attribute and its Association then its read/write permissions will preferably be the same as the Object.

### Assoc Default Rules

An Association preferably tells that its corresponding Attributes and values should be permissioned differently to rest of the Object. For each of read and write the Association preferably may specify one of
Owner: The read/write permissions for the Attribute will be the Object Owner only;
Trusted: The read/write permissions for the Attribute will be the Owner's Trusted group; and
Public: The read/write permissions for the Attribute will be Public

### Specific Permissions

The owner or an Object administrator preferably overrides the Object and Assoc defaults and set any read/write permissions for the specific Attribute.

The authorization scheme just described may be further understood with the help of an example with respect to an Object of the Class Person.

### Owner

For example an Object of Class Person. Person extends SelfOwned so the Owner of a Person is themselves.

### Object Permissions

By default we have:
Read: Owner's Trusted Group
Write: None (i.e. only Owner)
Delete: None (i.e. only Owner)
Admin: None (i.e. only Owner)

However the Person Class might overwrite some of these. For example suppose the Person Class sets
Read: Public

A specific Person though may be very reliant on a certain group and very private otherwise and may override this and set
Read: Owner's Trusted Group
Write: An ImmediateFamily Group created by Owner; A CloseWorkColleagues Group created by Owner

### Attribute Permissions

By default the Object's Attributes will inherit the Object's permissions:
Read: Owner's Trusted Group
Write: Owner's Trusted Group

However some Assoc's might change this. For example the SocialSecurity Assoc might set:
Read: None (only Owner)
Write: None (only Owner)

Finally the Owner may override permissions for a specific Attribute—say their name is not sensitive:
Read: PublicGroup

### Detailed Description of a Second Embodiment: A Federated General Object Graph

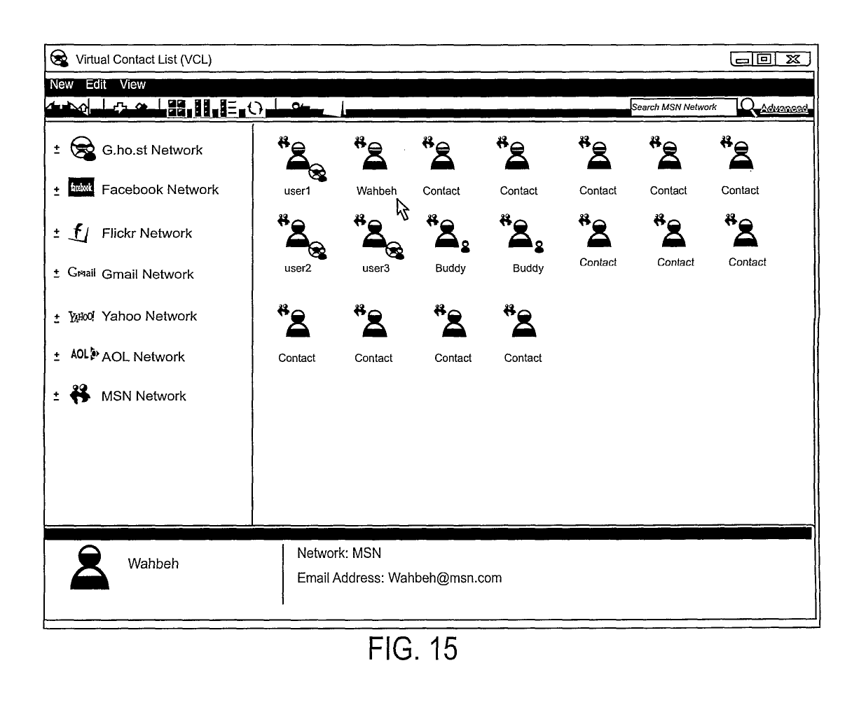

According to a second embodiment there is not one General Object Graph 114 as in FIG. 1, but a Federated General Object Graph which is comprised of Object Graphs provided by different service providers in different formats (some of which may be General Object Graphs in the sense of having a flexible schema and supporting user collaboration) and a central system for navigating and managing the object graph in a consistent way and specifically for adding user metadata. As illustrated in FIG. 14, data center 100 further provides a Federated General Object Graph including optionally General Object Graph 118a (persisted as 2015 and 2016), which cooperates with Object Graph 118b provided by each Third-Party data provider 2001, together termed Federated General Object Graph 118. The above is described in an embodiment in which a portion of Federated General Object Graph 118 is maintained as part of data center 100, however this is not meant to be limiting in any way. In another embodiment Federated General Object Graph 118a is not provided, and instead Server 115 coordinates and centralizes access to the various Federated General Object Graphs 118b.

The overall design of this second embodiment may be understood by reference to FIG. 14. A plurality of Third party data providers 2001 each have data in object-oriented format or in another format such as a relational database which can however be mapped to object-oriented data. The data may be public, may be private to a specific user account or may be shared.

For each data provider, an adapter 2002 is provided which preferably:
Provides metadata about the data source and about it's APIs;
Provides one or more standardized way to do single-sign-on to any private data stores; and
Provides a consistent API for querying/editing the data

The adapter may be provided by third party data provider 2001, by the provider of API 120, e.g. running within data center 100, or by a third-party.

In this design Client 111 accesses third party data either via the server 115 using API 120, directly to Data adapters 2002, or directly to third party data provider 2001. However Browser 110 may prevent direct communication between Client 111 and the domain of data adapters 2002 and/or third party data provider 2001 if Client 111 is a web page not downloaded from the same domain. Thus, preferably proxy server 2005 is provided as part of data center 100 to forward requests to data adapters 2002 and/or third party data provider 2001.

Database 113 will capture extra metadata which users of the Federated General Object Graph may want to add to data objects stored at third-parties—this includes private metadata 2011 (such as a user adding their personal tag or note on an Object) and public metadata (such as user reviews or ratings) 2010.

Additionally to the third-party services, Federated General Object Graph 118 may provide some native object oriented storage for public objects 2015 and storage for private objects 2016, e.g. using the techniques of the first embodiment of General Object Graph 114.

In another embodiment server 115 and/or database 113 may actually be run as part of Client 111 or any other combination without exceeding the scope of the invention.

### Metamodel Extensions

Some extensions to the Metamodel of FIG. 2 are preferably implemented for Federated General Object Graph 118, some of which are illustrated in FIG. 13, as follows:
Conceptually we note that multiple Objects at different data providers may describe the same real-world Item
The Object ID (labeled OID or IID) will preferably be a concatenation of
   A unique identifier of the service provider (e.g. the URL of their adapter or source metadata);
   A unique identifier of the user account at the service provider if private data, e.g. a username; and
   A unique id used by that service provider to uniquely identify data objects
Objects will preferably point at each other with compound values which (instead of pointing at the IID of the other object) identify the other object by some unique attribute value. The reason is that there might now be multiple objects in different data source describing the same person John Smith; so if we want to point at him (e.g. Jane's spouse attribute points to John Smith) it is preferable not to point at one specific object about John Smith but to point at him using a unique attribute or attributes such as social security number or name+mobile phone number.
Since multiple objects might describe the same real world item it is preferable to have a relationship of “extends” from objects to objects—so that one object about John Smith can say that it extends another object (optionally at a different data provider) and incorporate the other Object's attributes by reference while adding further references.
Since objects are often not in the user's control, a concept of user metadata will be introduced where the central system can capture user tags, comments, ratings or even attributes that the user wishes to add to objects stored by third parties. The metadata is optionally implemented as a full object in public objects 2015 and private objects 2016, described above in relation to FIG. 14, which extends the object or shortcuts containing just metadata of Public Metadata 2010 and Private Metadata 2011 of FIG. 14.

### APIs

The API for Federated General Object Graph 118 can be almost identical to the REST API described above for General Object Graph 114 just taking into account the different format of OID's and composite values.

In Federated General Object Graph 118 there are typically two levels of APIs, the federated API 120 and the API of the specific data adapters 2002. Optionally both can use the same style optionally with just different domains.

API 120 for General Object Graph 114 can be extended with user metadata to achieve Federated General Object Graph 118. Extra APIs may be supported for creating records in Public metadata 2010 and Private Metadata 2011.

For example:

POST http://federated-general-object-graph.com/objects/{OID=serviceProviderID-accountId-ObjectID}/tags?newTag=Personal

### Data Source Metadata

Associated with a Third-Party data provider 2001 there is preferably data source metadata which may be coupled to data adapter 2002 and provided by the Third-Party data provider 2001, by the provider of Federated General Object Graph 118a or even by a third party. The data source metadata provides details of the capabilities and of the specific API of the data source. Optionally, two separate sets of metadata are provided: one for the underlying Third-Party data provider 2001, which may not be compliant to a standard API, and one for data adapter 2002, which optionally has a more standard API wrapping the API of Third-Party data provider 2001.

Preferably the data source metadata is put in an XML file made available at a URL using a standard Web server. In this way a user who wants to add a data source to the system, whether an administrator adding a source for everyone's use, or a user adding a source for their own personal use, needs only specify the URL of the drive metadata file and the system will be able to read all parameters of the drive from that URL. Advantageously, by placing metadata in an XML file on the Web, search engines can find the new data source. Such metadata can be supplied either by Third-Party data provider 2001 or by a third party.

Metadata for a data source might include:
Legal name of service provider
Name of service
Description of service
Icons for service (in different sizes)
URL of terms of service
URL of sign-up
URL of standard interface (whether native or adapter)
Authentication protocols and parameters
API for generating a sessionID (or temporary password) if supported
Indication of standard for authenticating specific API calls e.g. OAuth or Digest Access Authentication
List of Classes supported
For each class list of Associations provided
Is user metadata supported—for example tags, notes
Methods provided in API: e.g. Create object, Read object, set attribute and query.

### Adapters

The function of data adapters 2002 has been described above in relation to FIG. 14. In an embodiment in which the Metamodel is realized as classes in an object oriented programming language framework such as Java or .net, the Metamodel may be used as a neutral format representing data as it is transferred from one API to another. The adapter can also map method implementations to proprietary calls on the service provider. The adapters may also perform single sign-on as further explained below.

### Object Metadata

In one embodiment, metadata is added to an object stored with a Third-Party data provider 2001, by created in one of public objects stores 2015 and provide objects store 2016 a new extender Object. The extender Object extends a third-party Object in accordance with the extended Metamodel, as described above in relation to FIG. 13, and preferably adds one or more of: extra attributes; a note; a list of tags (strings picked out of a pool of strings which the user calls tags); rating; and voting.

In an alternative embodiment, each of public metadata 2010 and private metadata 2011, as described above in relation to FIG. 14, contain just metadata on other objects and form a sort of shortcuts. Each such shortcut with metadata may for example contain some or all of the following parameters which may easily be persisted in a relational database, object data, simpleDB, XML files on a file system or otherwise:
OID of object pointed to;
User id of user creating metadata;
Note;
List of tags;
List of attributes (association ID, value pairs); and
Rating (a vote of 1-5 for example).

### Server

The role of the server or servers 115 is to implement the business logic layer of the Federated General Object Graph 118, preferably using a well known 3-tier architecture of persistence/business logic/presentation.

Requests will come into server 115 from API 120 and be processed accordingly, being forwarded as required to database 113 or to data adapter 2002, or alternatively to consult the data source metadata and use the data source metadata to formulate a request directly to third-party data provider 2001.

For example a user may use the navigator, described above in relation to FIG. 8, to indicate adding an attribute to an object. Client 111 will send a request to API 120 such as:

POST http://general-object-graph.com/{OID}/attributes/{attribute-name}, with the attribute value in the body of the POST

Server 115 will process the OID to retrieve the respective identifier for Third-party data provider 2001, e.g. ThirdPartyInc, and look up the service provider API in an optional directory of service providers and data sources. Alternatively the actual URL of the data source or of its metadata maybe part of the URL. The server logic will then POST a request such as:

POST http://adapter-for-ThirdPartyInc.com/{service provider's id}/attributes/{attribute-name}

Data adapter 2002 converts this into a call to the service provider's proprietary API. Optionally some or all of data adapter 2002 may be soft-coded, such as in the format of tables, to map the class and association names used by Federated General Object Graph 118 to those used by the data source provider.

In an alternative workflow, Client 111 will actually call adapter-for-ThirdPartyInc.com directly or via proxy server 2005.

### Federated Features

Optionally, server 115 offers some features which are not passed on to one Third-Party data provider 2001 but federated to several e.g. using parallel execution threads. This include, without limitation, some or all of:
Search for objects by key word;
Query objects by Category and attribute value ranges (might be automatically federated to any data source including data of that Category); and
Bulk changes to objects.

### Federated Schema

In one embodiment, the schema in Federated General Object Graph 118, i.e. the Class and Associations, are only allowed in a centrally stored aspect of the graph e.g. in the central public objects store 2015.

In another embodiment all data sources of database 113 may have schema Objects, and Objects from one data store may point at schema Objects from another.

### Navigator for Federated General Object Graph

The navigator for Federated General Object Graph 118, as described above in relation FIG. 8 in related to an embodiment of General Object Graph 114, is in one embodiment based on the navigator for General Object Graph 114. Additions preferably include, some or all of:
An ability for the user to control which data sources they are navigating including preferably finding data sources in a directory, searching for data sources, or configuring data sources and “mounting” them (so that they then appear in the user interface) by providing to the navigator the URL of their source metadata or of their API;
The ability to add metadata to any object—specifically a system for managing tag values and searching across multiple service providers by tag; and
An extra indicator on every icon showing which data source provider it is stored with.

It will be appreciated that icons for Federated General Object Graph 118 may be general or may be specialized to specific Classes or sources and may be embedded as components in general applications.

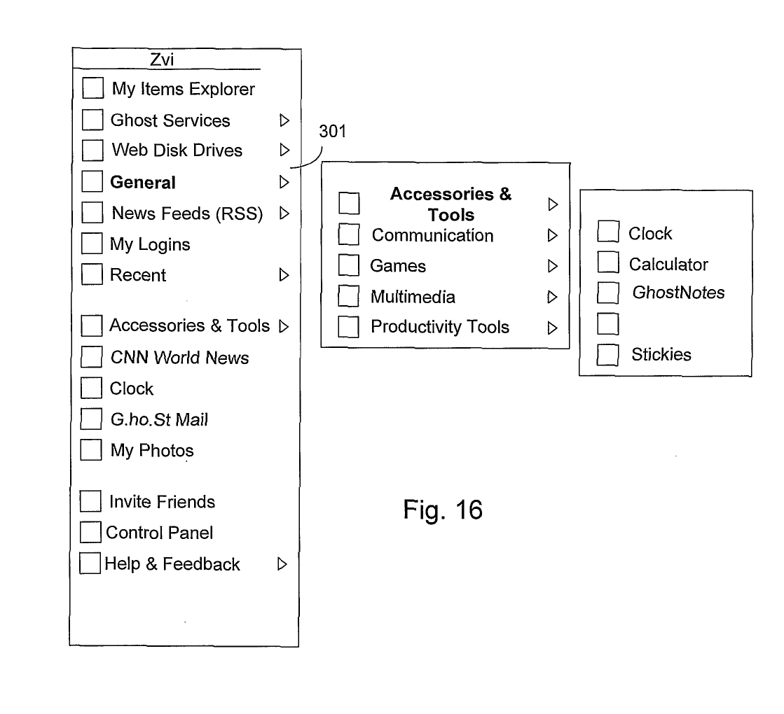

FIG. 15 illustrates a sample navigator specialized on one Class of Federated General Object Graph 118. The navigator of FIG. 15 is in one embodiment an instance of Client 111 run within browser 110 on terminal 105. The sample navigator of FIG. 15 shows the user interface of a contact management system which is built on top of Federated General Object Graph 118 with multiple data sources (represented in left hand panel) and which however accesses only data of type, denoted Contact, from all the sources and provides a user interface specifically relevant to working with contact and accessing the Methods of the contacts.

### Data Source Directory

In certain embodiments, as described above, database 113 includes a directory of available Third-Party data providers 2001 and all their metadata. It may be hard coded as an application or soft-coded as part of the schema and objects of the General Object Graph.

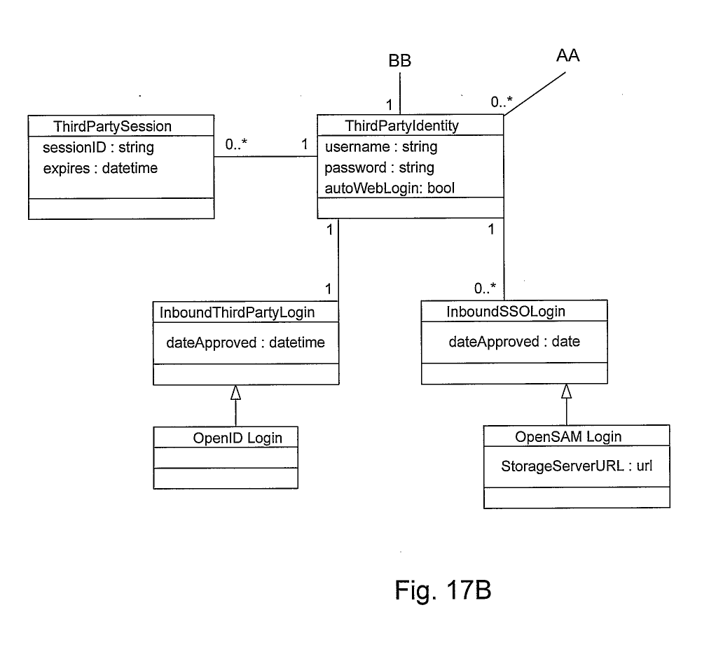

FIGS. 17A and 17B, which together form a single FIGURE, illustrate a UML class diagram for matching services with objects and actions according to certain embodiments of the invention. In one particular embodiment this is implemented as a Data Source directory, within database 113, as a special case of a more general web services applications directory with an object-oriented model such as that illustrated in FIG. 17A, the main concepts of which are descried as follows with an emphasis on capturing full information about how to do single sign-on to the service:
ServiceProvider: A company which provides Web services such as Google Inc., Yahoo Inc. and many others
ThirdPartyAccountType: A set of services you can sign up/on for (usually one per service provider but not always)
WebAuthenticationScheme: A scheme for doing SSO for browser Web pages associated with a ThirdPartyAccountType
CreateSessionAPI: Details of an API for supplying a username and password and receiving a session ID if session id's are supported by this ThirdPartyAccountType (some web services APIs prefer that username and password is presented once, usually securely over HTTPS, and then a sessionID is generated which is like a temporary password which may be used to authenticate subsequent API calls for a predetermined period of time.
APICallAuthenticationScheme: A scheme for signing/authenticating 114 calls to APIs associated with the ThirdPartyAccountType (if any) e.g. Digital Access Authentication
ServiceOffering: A service offered by a ServiceProvider (e.g. a web page, web app software-as-a-service, Object storage e.g. with a WebDAV interface, other APIs etc.). A WebApp which is launched by pointing a browser at a URL is an important special case.
MemberServiceOffering: A service which requires an account and sign-on. Providing Objects or other resources using the WebDAV protocol is an important special case.

It will be appreciated by those skilled in the art that object-oriented inheritance can be conveniently used to add many specific schemes. By way of a non-limiting example DigitalAccessAuthentication is one way to authenticate API calls.

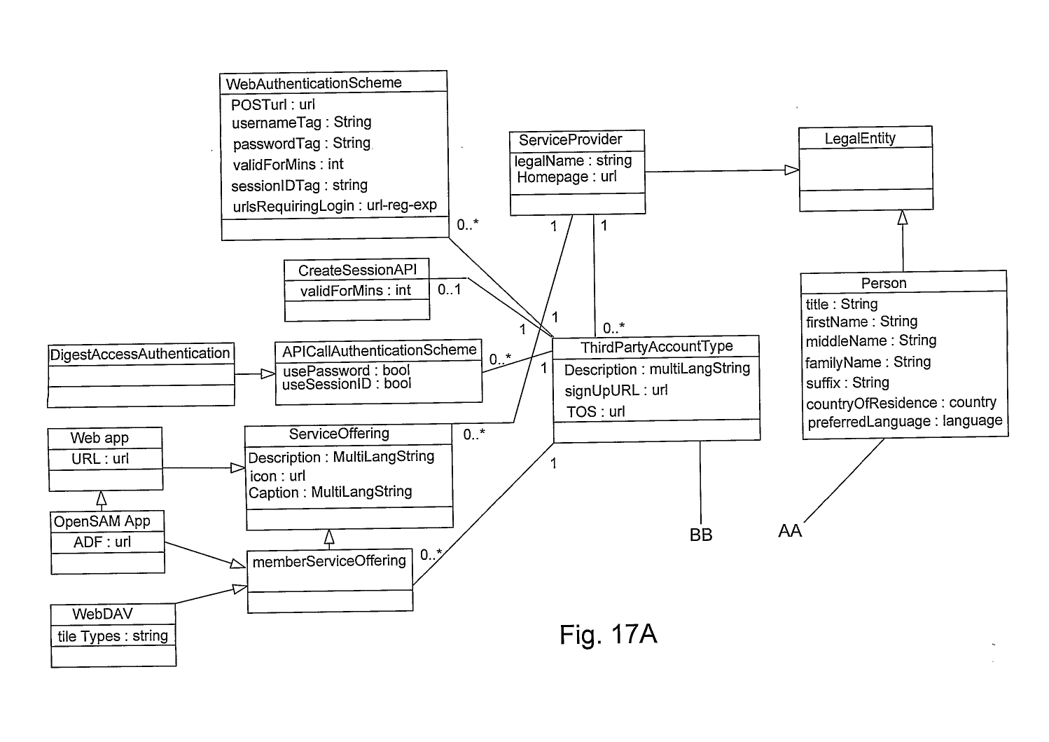

FIG. 16 illustrates a user interface for a directory which may also be applied to a data source directory. A sample simple GUI for a directory of applications which may be specialized to a director of Data Sources, denoted 301, in which services have been categorized using a hierarchy of categories (like folders). Additionally metadata can be shown in mouseovers, using context menu and other known GUI techniques. Search may also be provided.

### Outbound Single Sign on (SSO) for the Federated General Object Graph

Server 115, or Client 111 on behalf of the user, or data adapter 2002, may need to make API calls to Third-Party data providers 2001 or other service. In one embodiment the user has Objects stored with the Third-Party data provider 200 which are accessible using an API such as WebDAV.

The API call will typically require authentication especially if the Objects are private. Cookies are not usually used—more often the calling party will ‘digitally sign’ the call by attaching a digest of the call together with the username and password or using a sessionID, using known cryptographical techniques.

In one particular embodiment, Federated General Object Graph 118 is coupled to an identity management functionality such that a user may store their third-party login credentials (in a format such as: user id, service provider id, username, password) in identity repository 1006 and optionally also cached in client 111. The identity management functionality may be hard coded as an application or soft-coded as part of the schema and objects of the General Object Graph. One possible model for the identities (and associated sessions described below) are the classes ThirdPartyIdentity and ThirdPartySession shown in FIG. 17B.

A plurality of embodiments are now described which enable the use of identity repository 1006 to achieve SSO:
Client 111 generates a URL with authentication and calls Third-Party data provider 2001 directly—however browser 110 will typically prevent this;
Client 111 generates a URL with authentication and calls Third-Party data provider 2001 via proxy server 2005;
Client 111 generates a URL without authentication and calls proxy server 2005 which adds authentication and forward the request to the respective Third-Party data provider 2001;
Client 111 calls server 115 which has its own API 120, as described above, and server 115 wraps the call with business logic which in turn accesses the respective Third-Party data provider 2001 API
Client 111 calls server 115 which computes the URL for the target Third-Party data provider 2001 including necessary authentication and returns an HTTP redirect response or another response including the authenticated API call.

In, every one of these four approaches there are common steps, detailed below.
Before making an API call to a Third-Party data provider 2001, a data source directory, or a more general app directory 2030 in database 113, which is not limited to data sources, is consulted to discover the API authentication scheme(s) supported by the Third-Party data provider 2001.
If a sessionID is required (or desired) a cache of sessionIDs 1013, which is optionally further stored on Client 111, is consulted for an existing sessionID, and if not present the data source metadata should include a record of the API for obtaining a sessionID, this is consulted, and an API call is generated to get a sessionID which is then preferably cached in cache of sessionIDs 1013.
The data source metadata preferably includes details of how to authenticate API calls e.g. by indicating one of the known standards such as OAuth (oauth.net). This record is retrieved (if more than one, one is chosen according to what is preferred by the service provider or the protocol considered more secure or efficient by server 115)—for each major protocol, software code is available to authenticate the API—for example by implementing OAuth or the Digest Access Authentication—this code is used to authenticate the desired API call
The authenticated API call is forwarded to the Third-Party data provider 2001.

### Using Third-Party Clients

Much of the description has assumed that a single Client 111 is used to navigate all data sources. In another embodiment a third party Object explorer client is embedded. In one particular further embodiment the third party Object explorer client is embedded using HTML iframes or pop-up windows.

A typical workflow is as follows, as illustrated in FIG. 11:
User opens a browser and navigates to a domain associated with data center 100 and the browser downloads Client 111.
User logs in to Client 111, or to an associated home application which Federated General Object Graph 118 is embedded in.
User browses third party services using app directory 2030 within the home application or Client 111
User issues a command to Client 111 to launch a third-party web application found in the directory, for example offered by FourthPartyInc, and associated with URL http://fourth-party.com/AnotherService which might be an explorer for a Objects and folders
Client 111 queries app directory 2030 and finds that this service has an API for generating sessions IDs which may be used instead of Web login.
Client 111 optionally checks sessionID cache 1013, containing data in a format such as service provider; user id; session id; expiry time, and if required queries a database of the user's third party identity information stored on identity repository 1006, and then makes a call to get a session ID. For example the call may be formatted as:
   POST https://third-party.com/api/getSessionID?username=Fred&password=xyz. The returned sessionID will be returned to client 111 and/or stored in session ID cache 1013 mentioned above
Client 111 tells browser 110 to open an iframe to http://thirdparty.com/SomeService?sessionID=12345
For the predetermined time period for which the session ID is valid, any new request by the user to access services from ThirdPartyInc—the Client will attach the same sessionID retrieved from sessionID cache 1013
The next request after the expiration of the sessionID will be treated as above for a request in which no valid sessionID is found.

### Sign Up

In accordance with certain embodiments of the inventions, a user interface, such as a home application, associated with Federated General Object Graph 118 helps the user to create accounts with third party data source providers. In one particular embodiment, this involves referring the user to the third-party's sign-up page opened e.g. in an iframe or pop-up window. Furthermore, in certain embodiments, signUpUrl may be an additional attribute of the metadata for a data source.

In one particular embodiment, third-party accounts are made using an API call. In an non-limiting example an API may be a POST with tags equivalent to:e
Preferred username;
Preferred password;
FirstName;
FamilyName;
DateOfBirth;
Country;
PreferredLanguage; and
other parameters typical of registration.

For each such parameter a tag name and an indicator or required/optional/not-supported may be all be added to app directory 2030 so that there is enough data for automatic sign-up to the third-party.

Preferably the home application will digitally sign calls to the third-party sign-up API so that the third-party can trust the call. Preferably it is up to the home application, associated with Federated General Object Graph 118, to require a “captcha” test to validate that the user is human.

Thus, the present embodiments enable a General Object Graph for sharing structured data between users and between applications and for social networking between the users, an associated graphical user interface and application to a virtual file system with an associated authorization scheme. A distributed version of the General Object Graph is also presented known as a Federated General Object Graph.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

The terms “include”, “comprise” and “have” and their conjugates as used herein mean “including but not necessarily limited to”.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description

1. A computer implemented system exhibiting persistence for a graph of objects where the schema of the objects is changeable at runtime, the system comprising:
a server supporting a General Object Graph, said General Object Graph comprising:
a plurality of Objects; and
a plurality of Classes,
a client application,
wherein instances of said client application are operative on a plurality of computing platforms each in communication with said server to view and edit the General Object Graph.

2. A computer implemented system according to claim 1, wherein instances of said client are operative to cache part of the General Object Graph.

3. A computer implemented system according to claim 1, wherein said server comprises multiple servers, and wherein the General Object graph is federated between said multiple servers.

4. A computer implemented system according to claim 1, wherein at least two of the multiple servers store data in incompatible formats.

5. A computer implemented system according to claim 3, further comprising an adapter operative to:
accept a request in a standard format addressed to a target one of said multiple servers;
adapt said standard format request to said incompatible format of said target server; and
forward said adapted request to said target server.

6. A computer implemented system according to claim 3, further comprising a database storing identity information associated with third-party providers of data source services.

7. A computer implemented system according to claim 1, further comprising a database storing identity information associated with third-party providers of data source services.

8. A computer implemented system according to claim 7, further comprising a single-sign-on functionality associated with said server and operative to automatically authenticate calls to said third-party providers of data source services.

9. A computer implemented system according to claim 7, wherein said single-sign-on functionality is further operative to automatically create accounts with said third-party providers of data source services.

10. A computer implemented system according to claim 1, wherein said General Object Graph is associated with a first service provider, and wherein the system further comprises a user metadata module operative to store metadata associated with an object stored by a service provider unrelated to said first service provider.

11. A computer implemented system according to claim 3, where the metadata of said user metadata module comprises one of a list of tags, and a note.

12. A computer implemented system according to claim 1, further comprising a plurality of data sources, each of said data sources exhibiting associated source metadata, said server operative, responsive to said source metadata, to automatically discover how to communicate with said associated data source.

13. A computer implemented system according to claim 1, wherein said client application is an interactive web page.

14. A computer implemented system according to claim 1, wherein said client application includes navigation components operative to display any of said plurality of Objects as an icon and visually indicated its relationships to other Objects

15. A computer implemented system according to claim 14, where said navigation components are restrictable to show specific classes of objects.

16. A computer implemented system according to claim 14, wherein said navigation components are further operative to associate an object to a class by drag-and-drop.

17. A computer implemented system according to claim 14, wherein said navigation components are further operative to couple to an icon a method for a user related to the object depicted in the icon to communicate with another user related to the object depicted in the icon.

18. A computer implemented system according to claim 1, wherein the general structure of said General Object Graph is determined by a Metamodel.

19. A computer implemented system according to claim 17, wherein said Metamodel is associated with a set of validity constraints.

20. A computer implemented system according to claim 18, where said Metamodel indicates methods associated with said classes, said methods operative to determine the actions applicable to particular Objects which instantiate that Class.

21. A computer implemented system according to claim 20, wherein the Metamodel indicates the ability to relate a plurality of said method implementations to a class.

22. A computer implemented system according to claim 18, wherein said Metamodel indicates that one of said Object may be an instance of an arbitrary number of said Classes.

23. A computer implemented system according to claim 18, wherein said Metamodel allows multiple inheritance between said Classes.

24. A computer implemented system according to claim 18, wherein said Metamodel indicates that one of said Objects may extend another of said Objects.

25. A computer implemented system according to claim 18, wherein the Metamodel indicates a datatype of internationalized strings containing multiple translations of a string.

26. A computer implemented system according to claim 18, wherein the Metamodel indicates a datatype of a value which may be voted on.

27. A computer implemented system according to claim 18, further comprising an application programming interface for manipulating the General Object Graph.

28. A computer implemented system according to claim 18, wherein said server is further operative to persist a history of the General Object Graph.

29. A computer implemented system according to claim 18, wherein said General Object Graph exhibits a Metamodel with Concepts, wherein said Concepts are divided into versioned concepts and immutable concepts.

30. A computer implemented system according to claim 18, wherein at least one of said versioned concepts and immutable concepts are divided into archivable concepts and immortal concepts.

31. A computer implemented system according to claim 1, wherein said Classes comprise Classes for files and folders.

32. A computer implemented system according to claim 30, wherein said Objects comprise Objects which are instances of files representing files from a plurality of service providers.

33. A social networking system comprising:
a persistence server;
an object graph including concepts of classes, associations, objects and attributes, stored on the persistence server, where some of the objects correspond to real world items; and
a client software operative to enable a plurality of users to view the object graph, wherein
at least one of the classes represents a class of people; and
at least one of the associations has a source or type of a class which represents a class of people.

34. A social networking system according to claim 33, wherein said class which represents a class of people has an association which represents a means of interpersonal communication.

35. A social networking system according to claim 33, wherein the client software is coupled to a communications device.

36. A social networking system according to claim 33, wherein users may add and edit classes at runtime using the client software.

37. A social networking system according to claim 33, where the associations and corresponding attributes are typed.

38. A social networking system according to claim 37, where one of the types available for associations is a user-rating.

39. A system for data interoperability between applications comprising:
a persistence server;
an object graph including concepts of classes, associations, objects and attributes, stored on the persistence server, where some of the objects correspond to real world items;
a graphical user interface including icons which correspond to the objects; and
a graphical user interface for moving the icons between different applications.

40. A system for data interoperability between applications according to claim 39, wherein users may edit the classes at runtime.

41. A computer implemented method for persisting a graph of objects where the schema of the objects is changeable at runtime, the method comprising:
providing a General Object Graph; and
providing a client application,
wherein said General Object Graph comprises:
a plurality of Objects; and
a plurality of Classes,
wherein instances of said client application each provide for:
viewing and editing the General Object Graph.

42. A method according to claim 41, wherein instances of said client application each provides for caching part of the General Object Graph.

43. A method according to claim 41, further comprising:
federating said General Object Graph between said multiple servers.

44. A method according to claim 43, wherein at least two of the multiple servers store data in incompatible formats.

45. A method according to claim 44 further comprising:
accepting a request in a standard format addressed to a target one of said multiple servers;
adapting said standard format request to said incompatible format of said target server; and
forwarding said adapted request to said target server.

46. A method according to claim 41, further comprising: storing, at least one server hosting said General Object Graph, identity information associated with third-party providers of data source services.

47. A method according to claim 46, further comprising automatically authenticating, in cooperation with said stored identity information, calls to said third-party providers of data source services.

48. A method according to claim 46, further comprising: automatically creating accounts with said third-party providers of data source services.

49. A method according to claim 41, wherein said General Object Graph is associated with a first service provider, the method further comprising storing metadata associated with an object stored by a service provider unrelated to said first service provider.

50. A method according to claim 49, where the metadata of said user metadata module comprises one of a list of tags, a rating and a note.

51. A method according to claim 41, further comprising automatically discovering, responsive to respective source metadata associated with each of a plurality of data sources, how to communicate with each of said data sources.

52. A method according to claim 41, wherein said client application is an interactive web page.

53. A method according to claim 41, further comprising displaying, responsive to a portion of said client application, any of said plurality of Objects as an icon; and visually indicating its relationships to other Objects.

54. A method according to claim 53, wherein said displaying is restrictable to show specific classes of objects.

55. A method according to claim 53, further comprising associating, responsive to a portion of said client application, an object to a class by drag-and-drop.

56. A method according to claim 53, further comprising coupling, responsive to a portion of said client application, an icon a method for a user related to the object depicted in the icon to communicate with another user related to the object depicted in the icon.

57. A method according to claim 41, further comprising determining by a Metamodel the general structure of said General Object Graph.

58. A method according to claim 57, wherein said Metamodel is associated with a set of validity constraints.

59. A method according to claim 57, wherein said Metamodel allows Classes which determines the structure of other Objects.

60. A method according to claim 57, where said Metamodel indicates methods associated with said classes, said methods determining the actions applicable to particular Objects which instantiate that Class.

61. A method according to claim 60, wherein the Metamodel indicates the ability to relate a plurality of said method implementations to a class.

62. A method according to claim 60, wherein said Metamodel indicates that one of said Object may be an instance of an arbitrary number of said Classes.

63. A method according to claim 60, wherein said Metamodel allows multiple inheritance between said Classes.

64. A method according to claim 60, wherein said Metamodel indicates that one of said Objects may extend another of said Objects.

65. A method according to claim 41, further comprising providing an application programming interface for manipulating the General Object Graph.

66. A method according to claim 41, further comprising persisting the General Object Graph.

67. A method according to claim 41, wherein said General Object Graph exhibits a Metamodel with Concepts, wherein said Concepts are divided into versioned concepts and immutable concepts.

68. A method according of claim 67, wherein at least one of said versioned concepts and immutable concepts are divided into archivable concepts and immortal concepts.

69. A method according to claim 41, wherein at least one Object of said General Object Graph comprises a datatype of internationalized strings containing multiple translations of a string.

70. A method according to claim 41, wherein said Classes comprise Classes for files and folders.

71. A method according to claim 41, wherein said Objects comprise Objects which are instances of files representing files from a plurality of service providers.
